(19) United States
(12) Patent Application Publication
(10) Pub. No.: US 2025/0103452 A1
(43) Pub. Date: Mar. 27, 2025

(54) DURABLE HANDLE MANAGEMENT FOR FAILOVER IN DISTRIBUTED FILE SERVERS

(71) Applicant: Nutanix, Inc., San Jose, CA (US)

(72) Inventors: Ashok Tellakula, Bangalore (IN); Atul Kumar, Noida (IN); Hemanth Kumar Thummala, San Jose, CA (US); Manoj Premanand Naik, San Jose, CA (US); Saji Kumar Vijaya Kumari Rajendran Nair, Cupertino, CA (US)

(21) Appl. No.: 18/393,187

(22) Filed: Dec. 21, 2023

(30) Foreign Application Priority Data
Sep. 27, 2023 (IN) 202311064865

(51) Int. Cl. G06F 11/20; G06F 16/176

(52) U.S. Cl. CPC G06F 11/2053; G06F 16/1774; G06F 2201/85

(57) ABSTRACT

Examples of systems described herein may manage durable handles for seamless failover. Durable handles may be stored in a persistent volume group. The persistent volume group may be moved, together with all or a portion of file share data, to another computing node responsive to an indication of a failure event. To accommodate asynchronous write shares, asynchronous write operations may also be provided to the target computing node. The asynchronous write operations may be processed before reconnecting clients to the file share.

### CROSS-REFERENCE TO RELATED APPLICATION(S)

This application claims priority to India Application No. 202311064865 filed Sep. 27, 2023, which is incorporated herein by reference, in its entirety, for any purpose.

### TECHNICAL FIELD

Examples described herein relate generally to virtualized environments. Examples of virtualized file servers are provided that may manage durable handles to facilitate failover when a computing node has an outage.

### BACKGROUND

Enterprises increasingly utilize distributed file servers to manage enterprise data. Complex distributed systems may provide access to one or more file shares. It may be difficult to coordinate outage of one or more computing nodes while maintaining usability of the system.

Planned outages may be beneficial for distributed and/or virtualized systems. For example, it may be advantageous to take a computing node down for upgrade. It may be advantageous to upgrade a component of the node and/or any software resident on the node. However, it may be complex to ensure non-disruptive operation of the system even during a time when one or more nodes are down for a planned outage.

### BRIEF DESCRIPTION OF THE DRAWINGS

FIG. 1 is a schematic illustration of a system arranged in accordance with examples described herein.

FIG. 2 is a schematic illustration of the system of FIG. 1 during a failover event.

FIG. 3 is a flowchart for failover operations in accordance with examples described herein.

FIG. 4 is a flowchart for failover operations arranged in accordance with examples described herein.

FIG. 5 is a schematic illustration of a clustered virtualization environment 500 implementing a virtualized file server (VFS) in accordance with examples described herein.

FIG. 6 is a schematic illustration of a clustered virtualization environment 600 arranged in accordance with examples described herein.

FIG. 7 illustrates an example hierarchical structure of a VFS instance in a cluster according to particular embodiments.

FIG. 8 illustrates two example host machines, each providing file storage services for portions of two VFS instances FS1 and FS2 according to particular embodiments.

FIG. 9 illustrates example interactions between a client and host machines on which different portions of a VFS instance are stored according to particular embodiments.

FIG. 10 is a schematic illustration of a computing system arranged in accordance with examples described herein.

### DETAILED DESCRIPTION

Certain details are set forth herein to provide an understanding of described embodiments of technology. However, other examples may be practiced without various of these particular details. In some instances, well-known computing system components, virtualization technology or operations, and/or software operations have not been shown in detail in order to avoid unnecessarily obscuring the described embodiments. Other embodiments may be utilized, and other changes may be made, without departing from the spirit or scope of the subject matter presented herein.

Distributed file servers may need to upgrade or otherwise failover nodes while users are connected. Sometimes, the file system protocol itself may provide for seamless reconnection. For example, server message block (SMB) shares may have a continuous availability (CA) feature that provides a seamless reconnect experience for existing SMB connections during upgrade. However, CA shares may have a performance penalty. For example, CA shares may require synchronous write operations be used. All write input/output (I/O) may be required to be synchronized to stable storage before responding to clients. Accordingly, examples described herein address a seamless reconnect experience during upgrade even when the CA feature is not enabled. Examples of non-disruptive upgrade are described. Examples may provide for some assurance of a seamless reconnect experience while not incurring the performance penalty associated with CA shares, such as synchronous write operations.

For planned failures, write operations may be synchronized for a period of time prior to a planned failure. Responsive to an indication of a planned failure, examples of computing nodes described herein may flush write operations to disk. During normal operation of the file share, asynchronous writes may be used. Asynchronous write operations may be stored in memory in some examples. Storing the write operations in memory, rather than on a disk, may achieve improved performance during normal operation. However, in response to a planned failure (e.g., upgrade and/or maintenance), write operations may be flushed (e.g., copied) to a disk. In this manner, the performance impact of storing write operations in disk may be reserved for planned failure scenarios, reducing a performance impact. In some examples, write operations are synchronized for a period of time before the planned failure.

In SMB connections to non-CA shares, files are opened by requesting durable handles. The durable handles facilitate reconnections by a client following disruption, such as network glitches, to the server. These durable handles are generally volatile, stored local to a node, and may be cleaned up or removed when the server node is taken down.

Generally, a durable handle for a file or other storage item allows the client to attempt to preserve and reestablish the open after a short disconnect (e.g., network disconnect). Durable handles generally allow seamless (e.g., transparent to the application) reconnection by a client if the connection breaks, while keeping locks/oplocks/share modes intact.

In examples described herein, the durable handles (e.g., durable open state) may be persisted before a planned outage. Additionally, other lock states may be persisted prior to a planned outage. The durable handles and/or states may be restored during node failover. Durable handles are accordingly stored in a persistent volume group that may be provided on each node of a distributed file server. When one node fails over to another, the persistent volume group moves to the destination node.

During high availability operation, when a failover is to begin, the SMB listening port may be blocked so a TCP reset is not sent back to the client, allowing the client to retry the connection. The server going down may stop the SMB server process, and flush the in-memory durable handles (e.g., durable handle state) to a database on the persistent volume group. During high availability takeover, the persistent volume group is transferred to the target node (e.g., the replacement node). The target node's SMB process may read the database on the persistent volume group and prepare to accept the durable handle reconnects.

This solution may provide for seamless reconnects for outages within a threshold time (e.g., within 60 seconds). This threshold time may be related to the length of time the durable handle database on the persistent volume group is present. In some examples, the database is cleaned up (e.g., deleted) after the threshold time. Accordingly, examples described herein may provide a “best efforts” reconnection solution, not necessarily a guarantee.

Examples described herein accordingly facilitate seamless reconnect experiences to file shares during planned failovers. An example of such a planned failover is an upgrade operation. During upgrade, one computing node and/or SMB process may be taken down for upgrade. During the upgrade of that computing node and/or SMB process, another computing node and/or SMB process in the distributed computing system may be used to access the file share or portions thereof previously accessed through the down computing node and/or SMB process. Advantageously, the outage for upgrade may occur seamlessly, even without using a CA feature.

Durable handles are typically available for shorter outages, like network glitches. After a threshold time, the durable handle may be deleted or unavailable, and the reconnect will not be effective using the durable handle. Generally, this threshold time may be as long as 70 seconds, although other threshold times may be used in other examples. Other threshold times that may be used for length of a viable durable handle include 10 seconds, 20 seconds, 30 seconds, 40 seconds, 50 seconds, and/or 60 seconds. Other thresholds may also be used. During the time the durable handle is valid, and the server-acknowledged writes are preserved, examples described herein may support reconnects after failover.

For planned failovers, such as upgrade, the durable handles (e.g., durable open state or durable handle state) may be stored in a persistent volume group before failover. The durable handles (e.g., open state information) may be stored in a persistent volume group prior to unmounting the disk including the persistent volume group from the SMB process and/or host computing node.

During failover, when the target SMB process is started, the target computing node may read the durable handles (e.g., persisted open global state) in the persistent volume group and rebuild the lock state before accepting the incoming traffic. In some examples, if the flushing and/or transfer of asynchronous write operations or the threshold time is exceeded, the durable handles may be cleaned up (e.g., deleted) prior to restarting the SMB process on the target computing node. This may compromise behavior of the reconnects; however, it may help ensure the data is accurate on the failover node.

Accordingly, examples of systems described herein may manage durable handles for seamless failover. Durable handles may be stored in a persistent volume group. The persistent volume group may be moved, together with all or a portion of file share data, to another computing node responsive to an indication of a failure event. To accommodate asynchronous write shares, asynchronous write operations may also be provided to the target computing node. The asynchronous write operations may be processed before reconnecting clients to the file share.

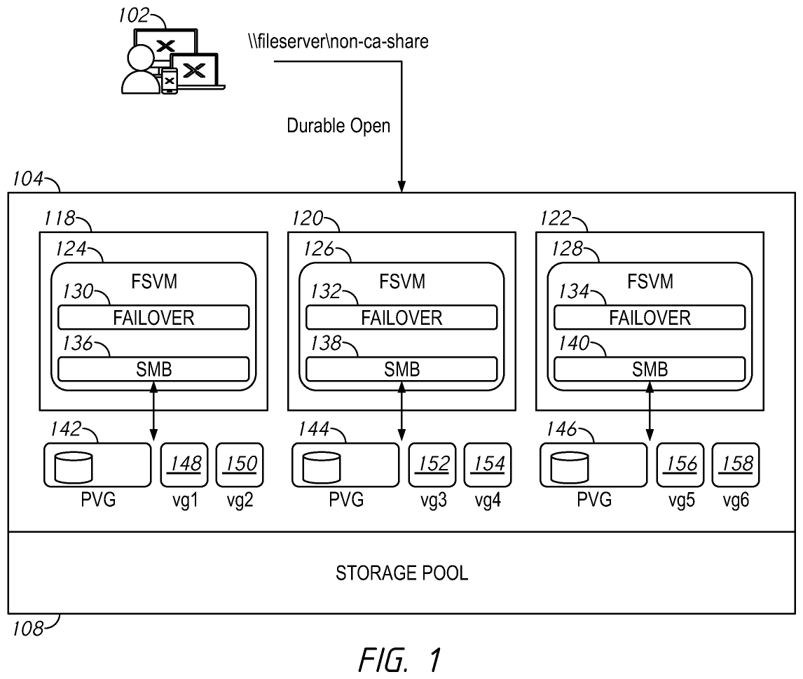

FIG. 1 is a schematic illustration of a system arranged in accordance with examples described herein. FIG. 1 depicts client 102 and system 104. The system 104 may include storage pool 108. The system 104 may include a virtualized file server. The virtualized file server may include computing node 118, computing node 120, and computing node 122. The computing node 118 may include a file server virtual machine (FSVM) 124. The computing node 120 may include FSVM 126. The computing node 122 may include FSVM 128. The FSVM 124 may include failover process 130 and SMB process 136. The FSVM 126 may include failover process 132 and SMB process 138. The FSVM 128 may include failover process 134 and SMB process 140. The FSVM 124 may manage persistent volume group 142, volume group (VG) VG1 148, and VG2 150. The FSVM 126 may manage persistent volume group 144, VG3 152, and VG4 154. The FSVM 128 may manage persistent volume group 146, VG5 156, and VG6 158.

The components shown in FIG. 1 are exemplary only. Additional, fewer, and/or different components may be present in other examples. For example, while three computing nodes with corresponding FSVMs are shown in FIG. 1, any number of computing nodes may be used. Generally at least three nodes may be used to provide a robust computing node cluster; however, two-node clusters may be used in some examples. Moreover, while FSVMs are shown in FIG. 1, any of a variety of virtualization technologies may be used to provide the failover processes and/or SMB processes shown, including one or more virtual machines (VMs) and/or one or more containers.

Examples of systems described herein may accordingly include one or more virtualized file servers, such as included in the system 104 of FIG. 1. A VFS may represent a logical entity in the system. Virtualized file servers described herein may be hosted in generally any virtualization environment (e.g., on generally any virtualization platform). The virtualization environment and/or platform generally refers to the storage resources that have been virtualized by the virtualized file server and the compute resources (e.g., computing nodes with processor(s)) used to manage storage. Examples of virtualization environments include, for example, on premises installations of one or more computing nodes and storage devices. Examples of virtualization environments include one or more cloud computing systems (e.g., Amazon Web Services, Microsoft Azure). Although not shown explicitly in FIG. 1, virtualization environments and/or virtualized file servers may include additional components including, but not limited to, one or more hypervisors, storage controllers, operating systems, containers, and/or container orchestrators (e.g., Kubernetes).

A virtualized file server may include multiple computing nodes, such as computing node 118, computing node 120, and computing node 122 of FIG. 1. Each computing node may include one or more processor(s) and computer readable media encoded with executable instructions which, when executed by the one or more processor(s), cause the computing node to perform operations described herein, including to provide one or more FSVMs, SMB processes, failover processes, and/or other components. The virtualized file server may include a cluster of VMs and/or other virtualized entities (e.g., containers), which may be referred to as file server virtual machines (FSVMs). In some examples, each of the FSVMs of a cluster may be implemented on different computing nodes forming a computing node cluster. For example, the FSVM 124, FSVM 126, and SMB process 138 of the virtualized file server of FIG. 1 may each be implemented on separate computing nodes of a computing node cluster used by the virtualized file server. In some examples, multiple FSVMs may be implemented on a cloud computing system.

In the example of FIG. 1 each FSVM is shown as providing an SMB process. For example, FSVM 124 provides SMB process 136. FSVM 126 provides SMB process 138. FSVM 128 provides SMB process 140. The SMB process refers to software (e.g., one or more non-transitory computer readable media encoded with instructions which, when executed by the computing node, cause the computing node to perform operations described herein as performed by the SMB process). The SMB processes, such as SMB process 136, may be provided in a virtualization technology, such as a virtual machine and/or a container. In the example of FIG. 1, the SMB processes are shown being provided by FSVMs. The SMB processes provide a protocol stack for accessing storage utilizing a file system protocol. One or more SMB processes may be implemented using an SMB server, for example.

The FSVMs may operate to provide a file system on the storage resources of the virtualized file server (e.g., the storage pool 108). The file system may have a single namespace and may store data in accordance with filenames and/or directories. The FSVMs may accordingly support one or more file system protocols, such as network file system (NFS) and/or SMB. In the example of FIG. 1, the FSVMs support SMB using SMB processes, such as SMB process 136, SMB process 138, and SMB process 140. A virtualized file server may translate file system protocol requests for one or more files and/or directories (e.g., a file path) into one or more storage requests to access the data corresponding to the file, directory, and/or file path. Any of a variety of components of the virtualized file server may be used to perform the translation (e.g., one or more FSVMs, one or more hypervisors, and/or one or more storage controllers). The translation may be performed using a map (e.g., a shard map) relating the location of the data to the file name, share, directory, and/or file path. The map may be maintained by the computing nodes used to form the virtualized file server.

Virtualized file servers described herein may be used to access a storage pool. For example, the virtualized file server of FIG. 1 may access storage pool 108. The storage pool may generally include any number or kind of storage devices-for example, network-attached storage, local storage of one or more computing nodes forming the virtualized file server, and/or cloud storage. Storage devices may be implemented using, for example one or more local storage devices, hard disk drives, solid state drives, network-attached storage, and/or cloud storage. The storage for a particular virtualized file server may be referred to as a storage pool. The storage may be arranged in one or more shares. In some examples, each file server virtual machine (FSVM) may manage (e.g., host) a corresponding share or portion of a share. A shard map may store associations between shares and files, directories, and/or file paths.

Examples of file server managers and virtualized file servers that may be used to implement systems described herein are further described in U.S. Published Application No. 2023/0056425, published Feb. 23, 2023, and entitled “File server managers and systems for managing virtualized file servers,” which publication is hereby incorporated by reference in its entirety for any purpose.

Examples of virtualized file servers described herein may utilize volume groups for storage of storage items, such as storage items in a file system (e.g., files, folders, directories). In some examples, the storage items may be arranged into one or more file shares. A file share may generally refer to a set of files having a particular folder and file hierarchy (e.g., directory structure and/or path).

Virtual disks (or “vDisks”) may be structured from the physical storage devices in the storage pool. A vDisk generally refers to a storage abstraction exposed by a component of a virtualization platform, such as a storage controller, hypervisor, and/or virtual machine. The vDisk is exposed for use by a client (e.g., a user, application, or service). vDisks may be mounted as a virtual disk on one or more VMs or other virtualization technology components (e.g., FSVM 124, FSVM 126, and/or FSVM 128 of FIG. 1). vDisks may be organized into one or more volume groups. For example, the SMB process 136 of FIG. 1 may access a mounted vDisk including VG1 148 and VG2 150. The SMB process 138 may access a mounted vDisk including VG3 152 and VG4 154. The SMB process 140 may access a mounted vDisk including VG5 156 and VG6 158. The volume groups may store all or a portion of a file share. In this manner, the FSVMs of FIG. 1 may provide access to all or portions of file shares included on the volume groups. The volume groups shown in FIG. 1 may be provided utilizing a storage controller present on each of the computing nodes. For example, although not shown explicitly in FIG. 1, a storage controller and hypervisor may be present on computing node 118. The storage controller and hypervisor may provide VG1 148, VG2 150, and persistent volume group 142. Storage controllers and hypervisors may be provided in an analogous manner on computing node 120 and computing node 122 of FIG. 1 to provide persistent volume group 144, VG3 152, VG4 154, persistent volume group 146, VG5 156, and VG6 158.

Examples of virtualized file servers described herein may utilize one or more persistent volume groups. The persistent volume groups may be utilized to persist certain data regarding a file share following a failover event. For example, the FSVM 124 may access a mounted persistent volume group 142. The FSVM 126 may access a mounted persistent volume group 144. The FSVM 128 may access a mounted persistent volume group 146. The persistent volume group may be used to store durable handles, other state information, and/or write operations. By storing some or all of that information in a persistent volume group, the persistent volume group can be moved to another computing node (e.g., another FSVM) as part of a failover procedure. The target computing node receiving the persistent volume group may accordingly utilize the persistently stored data for operation during or after failover. Accordingly, the persistent volume group 142 may store durable handles, other state information, and/or write operations for file shares or portions of file shares located on VG1 148 and/or VG2 150. In this manner, a persistent volume group mounted to processes at a computing node may store durable handles, other state information, and/or write operations for the file shares or portions of file shares whose input/output (I/O) access is managed by that computing node and/or by FSVMs or SMB processes on that computing node. The persistent volume group 144 may store durable handles, other state information, and/or write operations for file shares or portions of file shares stored on VG3 152 and/or VG4 154. The persistent volume group 146 may store durable handles, other state information, and/or write operations for file shares or portions of file shares stored on VG5 156 and/or VG6 158.

Examples of virtualized file servers described herein may include one or more failover processes. The failover process may be software (e.g., executable instructions encoded on a computer readable medium which, when executed by one or more processors, perform the failover actions described herein). For example, the failover process 130 may include executable instructions encoded on one or more computer readable media (e.g., memory) accessible to the computing node 118. When executed by a processor of the computing node 118, the executable instructions may cause the computing node 118 (e.g., the FSVM 124 or another component of the computing node 118) to perform the failover operations described herein.

Failover processes may provide high availability for file servers described herein. For example, failover processes may ensure that a computing node of a virtualized file server is available and configured to service I/O for each file share stored by the virtualized file server. The failover process 130 of FIG. 1 is provided on computing node 118. The failover process 132 is provided on computing node 120. The failover process 134 is provided on computing node 122. In the example of FIG. 1, the failover processes are included in the FSVMs. The FSVM 124 includes failover process 130. The FSVM 126 includes failover process 132. The FSVM 128 includes failover process 134. However, the failover processes in other examples may be present in other VMs, their own VMs, and/or containers or other components of the computing nodes. Moreover, the FSVMs of FIG. 1 each include a failover process and an SMB process. In some examples, these processes may be provided in separate or different VMs and/or containers.

Examples of systems described herein may be utilized (e.g., communicated with) by one or more clients, such as client 102 of FIG. 1. A client may be a human user and/or a software process (e.g., an application). The client 102 of FIG. 1 is shown utilizing a computing system which may be in communication with the system 104 (e.g., with a leader computing node of the computing nodes of the virtualized file server). In some examples, however, a client may be hosted by one or more of the computing nodes in a virtualized file server, such as computing node 118, computing node 120, and/or computing node 122 of FIG. 1. The client may be provided, for example, in one or more user VMs or containers on computing node 118, computing node 120, and/or computing node 122.

During operation, virtualized file servers described herein may service requests from one or multiple users for access to the one or more file shares stored in the virtualized file server. For example, the client 102 may provide a request (e.g., a read and/or write request) for a file share. The request may specify, for example, a pathname of a share and/or a file within a share. In the example of FIG. 1, the client 102 may request the share “\\fileserver\non-ca-share.” Other names, shares, and/or files may be used in other examples. The requested share is a non-CA share in that a “continuous availability” feature is not offered by the share. The request for the share generates a durable handle for the share and/or for the requested file of the share. The durable handle, which may also be referred to as a durable open, may be stored in a persistent volume group. The durable handle may be represented by data (e.g., metadata) that includes one or more fields and/or flags to indicate the presence of a durable handle for a share, file, and/or other storage item. Accordingly, the client 102 may provide a request for a share. As an example, the client 102 may request a share stored on VG1 148. The request may be received by any one of the computing nodes of the virtualized file server. In some examples, a leader node may receive the request. The request may be provided to a particular computing node (e.g., a particular FSVM) that manages the requested share and/or file or other storage item. For example, a request from client 102 for “\\fileserver\non-ca-share” may be received by computing node 120, which may be a leader node. The request may be received by FSVM 126 in some examples. The computing nodes may communicate with one another and/or the client to identify an appropriate computing node and/or FSVM to service the request. For example, the computing node 120 and/or FSVM 126 may access one or more maps to determine which FSVM and/or computing node should service the request. In the example of FIG. 1, the requested share may be present on VG1 148. Accordingly, the request may be provided to FSVM 124 in some examples. The durable open may be stored in a persistent volume group mounted to the process and/or computing node used to service the request. Accordingly, the durable handle in the example of FIG. 1 may be stored in persistent volume group 142.

The durable handles may be stored as they are created in the persistent volume group in some examples. Generally, the durable handle may refer to the durable open state for all or a portion of a file share. In some examples the durable handles may be stored during normal operation in a memory of a computing node, such as the computing node 118, computing node 120, and/or computing node 122. Responsive to an indication that a failover operation is to occur, the durable handles may be written to the persistent volume group. In some examples, storing the durable handles in the persistent volume group only responsive to an indication that a failover event is to occur may provide a performance improvement as it may avoid or reduce a need to write to the persistent volume group during normal operation.

In an analogous manner, other lock state information (e.g., lock states) may be stored in persistent volume groups described herein. Lock states for a file share may be stored in one or more persistent volume groups described herein. Examples of lock state may include shared mode, lease, and byte-range lock states.

During operation, one or more failover events may be planned. A failover event may include, for example, an upgrade or maintenance of a computing node and/or of an SMB process or a virtualization technology (e.g., a container or a virtual machine) including the SMB process. In examples described herein, systems may process durable handle and/or other lock state information in a manner that facilitates reconnect following a planned failover. Accordingly, a computing node and/or FSVM and/or failover process described herein may receive an indication of a planned failover. For example, the failover process 130 of FIG. 1 and/or the computing node 118 of FIG. 1 may receive an indication of a failover event. The failover process 130, for example, may receive an indication from a lead computing node and/or a client that an upgrade or maintenance event may occur at a particular time. Responsive to the indication of a failover event, the failover process 130 may in some examples flush asynchronous writes to disk. Recall that file shares maintained by systems described herein may be provided without a continuous available feature, and accordingly may support asynchronous write operations. The asynchronous write operations (e.g., the write operations acknowledged by the server) may be stored in memory of the computing node to which they are directed. For example, the computing node 118 may store asynchronous write operations for a file share stored in VG1 148 and/or VG2 150 in memory of the computing node 118. Responsive to an indication of a failover event, the failover process 130 may flush the write operations to a disk, such as to persistent volume group 142 and/or other storage in storage pool 108.

Responsive to an indication of a failover event, failover processes described herein may ensure that durable handles and/or other lock state information are present in a persistent volume group for a node to be taken down for the failover event.

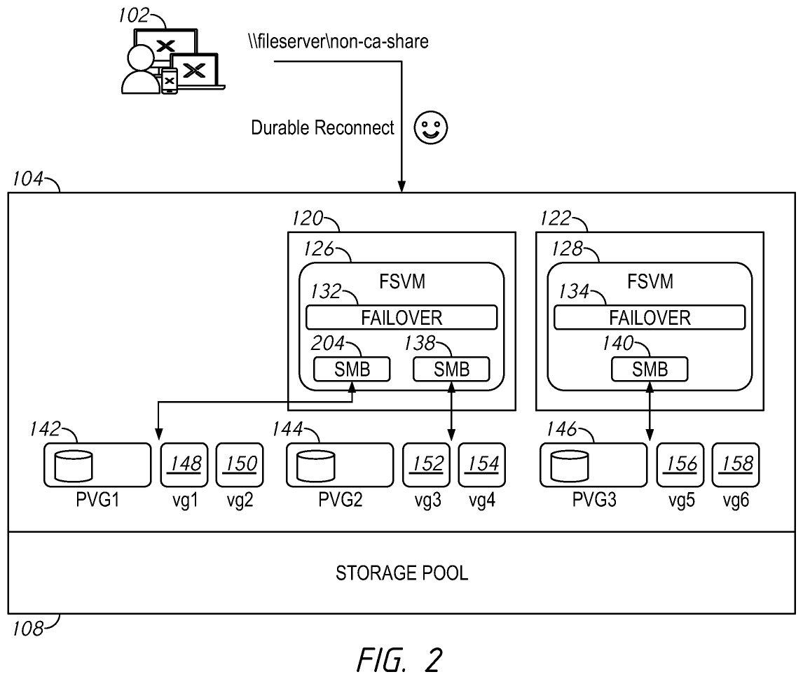

FIG. 2 is a schematic illustration of the system of FIG. 1 during a failover event. FIG. 2 utilizes the same reference numbers for the same components shown in FIG. 1. FIG. 2 depicts client 102 and system 104. The system 104 may include storage pool 108. The system 104 may include a virtualized file server. The virtualized file server shown in FIG. 2 may include computing node 120 and computing node 122. In the example of FIG. 2, the computing node 118 may be down for upgrade, maintenance, or other failover event. The computing node 120 may include FSVM 126. The computing node 122 may include FSVM 128. The FSVM 126 may include failover process 132 and SMB process 138. The FSVM 126 of FIG. 2 may additionally include SMB process 204. The FSVM 128 may include failover process 134 and SMB process 140. The FSVM 126 may manage persistent volume group 144, VG3 152, and VG4 154. The FSVM 126 may additionally manage persistent volume group 142, VG1 148, and VG2 150. Note that the persistent volume group 142, VG1 148, and VG2 150 may have been moved to computing node 120 and/or FSVM 126 from computing node 118 and/or FSVM 124 of FIG. 1. The FSVM 128 may manage persistent volume group 146, VG5 156, and VG6 158.

The components shown in FIG. 2 are exemplary only. Additional, fewer, and/or different components may be present in other examples. For example, while two computing nodes with corresponding FSVMs are shown in FIG. 2, any number of computing nodes may be used. Moreover, while FSVMs are shown in FIG. 2, any of a variety of virtualization technologies may be used to provide the failover processes and/or SMB processes shown, including one or more VMs and/or one or more containers. Still further, one computing node (computing node 120) is illustrated as hosting multiple SMB processes in FIG. 2. In other examples, another computing node (not shown in FIG. 2) may be used as a target to receive the persistent volume group 142, VG1 148, and VG2 150 from computing node 118 of FIG. 1.

Responsive to an indication of a failover event, one or more failover processes described herein may be utilized to move one or more volume groups from a computing node to be taken down to another target computing node. In the example of FIG. 1 and FIG. 2, the failover process 130, which may operate in coordination with failover process 132 and/or failover process 134, may move the persistent volume group 142, VG1 148, and VG2 150 to computing node 120 (e.g., to FSVM 126). Responsive to an indication of a failover event, an SMB process may be started on the target computing node to service requests formerly directed toward an SMB process that may be down due to the failover event. For example, the failover process 130, which may operate in coordination with failover process 132 and/or failover process 134, may start SMB process 204 on computing node 120.

In this manner, during a time that computing node 118 is down for a failover event, the computing node 120 may service the I/O requests formerly handled by the computing node 118. For example, the FSVM 126 may service I/O requests for file share(s) provided on VG1 148 and/or VG2 150 in an analogous manner to how those requests were serviced by FSVM 124 prior to the failover event.

Note that the persistent volume group 142 was also moved to the computing node 120 (e.g., to the FSVM 126). Data in persistent volume group 142 may be used to facilitate reconnect requests to one or more file shares, or portions of file shares, on VG1 148 and/or VG2 150. For example, the computing node 120 and/or FSVM 126 and/or SMB process 204 may access the durable handles in persistent volume group 142. The durable handles may be used by computing node 120 and/or FSVM 126 and/or SMB process 204 to respond to a durable reconnect request sent by a client, such as client 102. For example, the client 102 may determine that a request had not been fulfilled and/or had been interrupted. Accordingly, the computing node 120 may send a reconnect request. The reconnect request may be processed by the computing node 120 using durable handle information in the persistent volume group 142.

In some examples, prior to servicing reconnect requests or other requests for the file share or portions of file shares stored in VG1 148 and/or VG2 150, the computing node 120 (e.g., the FSVM 126 and/or SMB process 204) may process any asynchronous write operations provided from the computing node having gone down. For example, the asynchronous write operations may be stored in persistent volume group 142. The asynchronous write operations may be accessed by SMB process 204 and processed prior to servicing requests for the file share or portions thereof. In this manner, data consistency can be improved during or after failover. Further, in some examples, prior to servicing reconnect requests or other requests for the file share or portions of file shares stored in VG1 148 and/or VG2 150, the computing node 120 (e.g., the FSVM 126 and/or SMB process 204) may read any lock state information stored in persistent volume group 142 and may implement the stored lock states.

In this manner, an SMB process may be failed over from one computing node to another while allowing for durable reconnect requests. In an analogous manner, when the failover event is complete (e.g., when computing node 118 has been upgraded and/or maintained and has returned to communication with computing node 120 and/or computing node 122), the SMB process 204 may be returned from computing node 120 to computing node 118. The failover process 132 may store durable handles, lock state information, and/or asynchronous write operations to persistent volume group 142 and the persistent volume group 142 returned to computing node 120 (e.g., to FSVM 124). The SMB process 136 may be restarted on computing node 118 and may process the asynchronous writes and utilize the durable handles and lock state information to service I/O requests for VG1 148 and/or VG2 150.

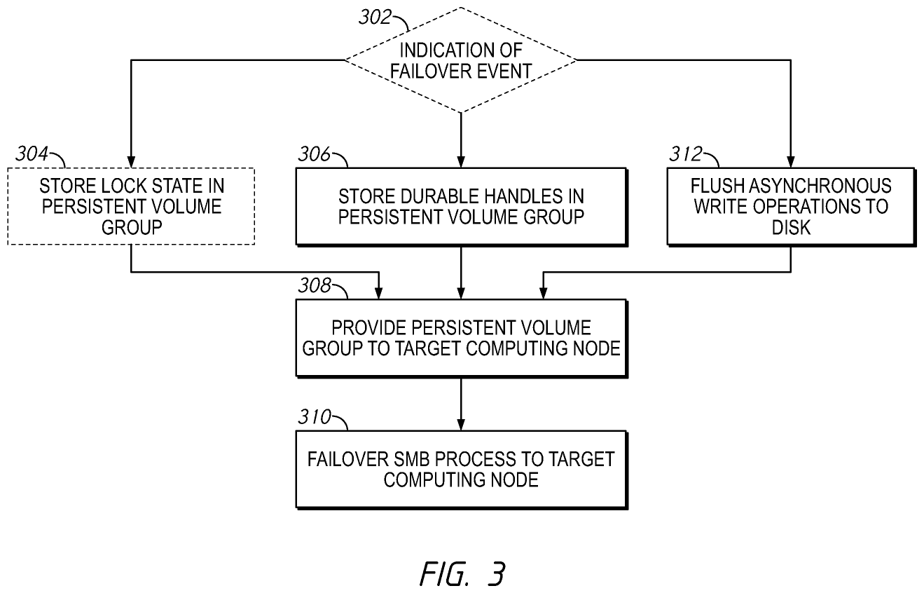

FIG. 3 is a flowchart for failover operations in accordance with examples described herein. According to some examples, the operations include receipt of an indication of failover event at block 302. According to some examples, block 304 may follow block 302. The operations include storing lock state in a persistent volume group at block 304. Block 306 may follow block 302. The operations include storing durable handles in the persistent volume group in block 306. Block 312 may follow block 302. According to some examples, the operations include flushing asynchronous write operations to disk at block 312. Block 308 may follow block 304, block 306, and/or block 312. According to some examples, the operations include providing the persistent volume group to a target computing node at block 308. Block 310 may follow block 308. According to some examples, the operations include failing over an SMB process to the target computing node at block 310.

The operations shown in FIG. 3 are shown by way of example. Additional, fewer, and/or different operations may be used in other examples. The operations of FIG. 3 may be performed by one or more systems described herein. For example, the system 104 of FIG. 1 and FIG. 2 may be used to perform the operations shown in FIG. 3. The operations of FIG. 3 may be implemented using executable instructions stored on one or more computer readable media which, when executed by one or more processors, may cause a system to perform the described operations. For example, the operations shown in FIG. 3 may be performed in some examples by computing node 118 of FIG. 1. Accordingly, the computing node 118 may include one or more computer readable media encoded with instructions which, when executed by a processor of the computing node 118, cause the computing node 118 to perform the operations of FIG. 3.

In block 302, an indication of a failover event may be provided. For example, the failover event may be a planned failover event, such as an upgrade or a maintenance event. The failover event may be an event which may cause a computing node and/or a portion of a computing node to go down, which may affect availability of a file share. The indication of a failover event may be provided, for example, by client 102 of FIG. 1 and/or one or more failover processes shown in FIG. 1, including failover process 130, failover process 132, and/or failover process 134. The failover indication may come from another component in other examples.

In order to handle the failover event, a variety of operations may occur that may support servicing reconnects for a file share. In some examples, durable handles may be stored in a persistent volume group in block 306. The failover process 130 and/or SMB process 136 and/or another component of the computing node 118 may store the durable handles to persistent volume group 142. The durable handles may be stored, for example, in persistent volume group 142 of FIG. 1 and FIG. 2. In some examples, the durable handles may be stored in persistent volume group 142 during normal operation. In some examples, the durable handles may be moved to persistent volume group 142 responsive to an indication of a failover event, such as the indication received in block 302.

In some examples, asynchronous write operations may be flushed to disk in block 312. For example, the failover process 130 of FIG. 1 may flush asynchronous write operations from a memory of the computing node 118 to storage in storage pool 108 and/or to persistent volume group 142.

In some examples, lock state information may be stored in a persistent volume group in block 304. The lock state information may be stored, for example, in persistent volume group 142 of FIG. 1 and FIG. 2. The failover process 130 and/or SMB process 136 and/or another component of computing node 118 may store the lock state information to persistent volume group 142.

To fail over, the persistent volume group may be provided to the target computing node in block 308. For example, the persistent volume group may be mounted to one or more VMs or made available to one or more other components of the target computing node. For example, the persistent volume group 142 of FIG. 1 may be mounted to FSVM 126 of computing node 120. The failover process 130 and/or failover process 132, and/or both of those processes together, may manage the movement of persistent volume group 142. In this manner, the target computing node (e.g., computing node 120 of FIG. 1) may have access to the durable handles, other state information, and/or asynchronous write operations.

In block 310 an SMB process may be failed over the target computing node. For example, the SMB process 136 of FIG. 1 may be failed over to SMB process 204 of FIG. 2. The failover process 130 and/or failover process 132 may manage the failover. The SMB process 204 may be started and may be configured to service I/O requests previously handled by the SMB process 136. For example, an internet protocol (IP) address or other identification of the SMB process 204 and/or FSVM 126 may be replaced for the IP address or other identification of the SMB process 136 and/or FSVM 124 such that requests previously directed toward SMB process 136 and/or FSVM 124 may be directed toward FSVM 126 and/or SMB process 204.

In some examples, failover processes described herein may defer opening of one or more ports (e.g., SMB ports) on a target computing node until the SMB process to provide failover is started. For example, the failover process 132 may defer opening a port used to access SMB process 204 until SMB process 204 is running. In some examples, if the port is opened prior to SMB process 204 being operational, a reconnect request may arrive before SMB process 204 is operational and may affect an overall amount of time the client attempts to send reconnects. In some examples, deferring opening of the port may increase the chance that the reconnect will be successful. For example, failover process 132 may defer opening one or more ports on the computing node 120 until SMB process 204 is started and/or the system lock state has been restored and/or asynchronous writes have been processed.

In an analogous manner, when failing over an SMB process, one or more ports may first be closed. This may block traffic to the SMB process that may be stopped. In this manner, traffic may be blocked from clients before stopping the SMB process. In some examples, this may also block immediate resets from a server. Accordingly, clients may be kept waiting longer and not immediately give up. For example, the computing node 118 (e.g., failover process 130) may block one or more ports of the computing node 118 (e.g., a network port used to receive a request from client 102) prior to stopping SMB process 136 for failover.

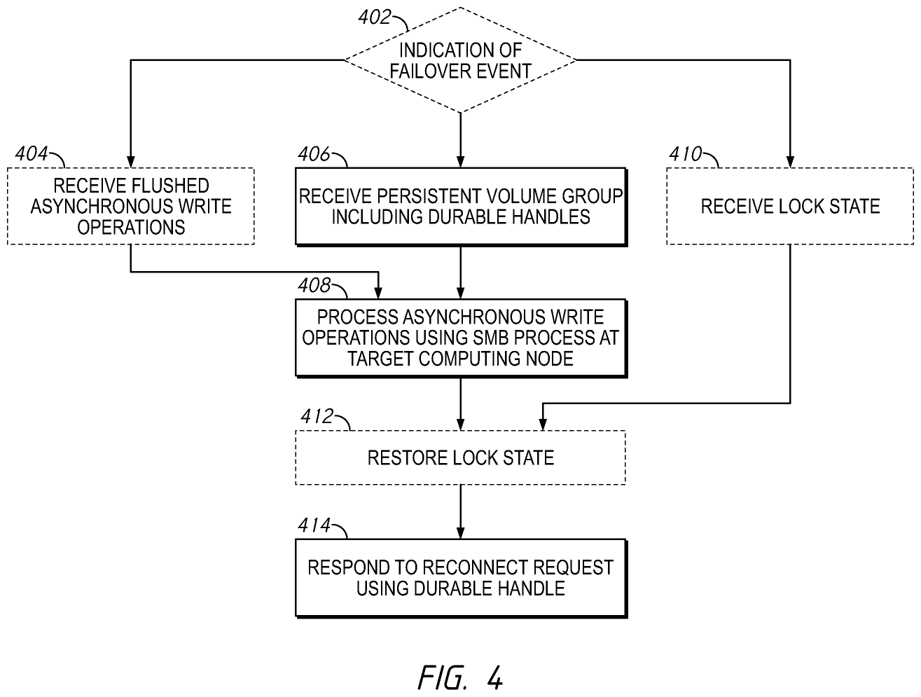

FIG. 4 is a flowchart for failover operations arranged in accordance with examples described herein. According to some examples, the operations include indication of a failover event at block 402. Block 404 may follow block 402. According to some examples, the operations include receiving flushed asynchronous write operations at block 404. Block 406 may follow block 402. According to some examples, the operations include receiving persistent volume group including durable handles at block 406. Block 410 may follow block 402. According to some examples, the operations include receiving lock state at block 410. Block 408 may follow block 404, block 406, and/or block 410. According to some examples, the operations include processing asynchronous write operations using an SMB process at the target computing node at block 408. Block 412 may follow block 408. According to some examples, the operations include restoring lock state at block 412. Block 414 may follow block 412 and/or block 408. According to some examples, the operations include responding to a reconnect request using a durable handle at block 414.

The operations shown in FIG. 4 are shown by way of example. Additional, fewer, and/or different operations may be used in other examples. The operations of FIG. 4 may be performed by one or more systems described herein. For example, the system 104 of FIG. 1 and FIG. 2 may be used to perform the operations shown in FIG. 4. The operations of FIG. 4 may be implemented using executable instructions stored on one or more computer readable media which, when executed by one or more processors, may cause a system to perform the described operations. For example, the operations shown in FIG. 4 may be performed in some examples by computing node 120 of FIG. 1 and/or FIG. 2. Accordingly, the computing node 120 may include one or more computer readable media encoded with instructions which, when executed by a processor of the computing node 120, cause the computing node 120 to perform the operations of FIG. 3.

In block 402, an indication of a failover event may be provided. For example, the failover event may be a planned failover event, such as an upgrade or a maintenance event. The failover event may be an event which may cause a computing node and/or a portion of a computing node to go down, which may affect availability of a file share. The indication of a failover event may be provided, for example, by client 102 of FIG. 1 and/or one or more failover processes shown in FIG. 1, including failover process 130, failover process 132, and/or failover process 134. The failover indication may come from another component in other examples.

As described herein and, for example, with regard to FIG. 3, examples of failovers described herein may include providing a persistent volume group to a target computing node. The persistent volume group may include durable handles, lock state information, and/or asynchronous write operations.

In block 406, a persistent volume group including durable handles may be received. For example, the computing node 120 of FIG. 1 may receive persistent volume group 142 from computing node 118. The persistent volume group may store durable handles relating to the file share, file shares, and/or portions of file shares stored in VG1 148 and/or VG2 150 whose management may be failed over from computing node 118 when computing node 118 goes down. The persistent volume group 142 may, for example, be mounted to FSVM 126 and/or otherwise made accessible to computing node 120. In addition to receiving persistent volume group 142, the target computing node may receive one or more volume groups that store the file share, file shares, or portions of a file share whose management is being failed over to the target computing node.

In examples described herein, in addition to receiving durable handles from the failing over computing node, target computing nodes may receive lock state information and/or flushed asynchronous write operations. In block 404, the target computing node may receive flushed asynchronous write operations. These may be, for example, asynchronous write operations that have been acknowledged by a server (e.g., by SMB process 136 and/or computing node 118), but not yet processed (e.g., the data has not yet been written). In some examples, the asynchronous write operations may have been flushed to a disk, such as to storage in storage pool 108 of FIG. 1 and/or to persistent volume group 142. The target computing node (e.g., computing node 120) may receive the asynchronous write operations from computing node 118, for example, by mounting persistent volume group 142.

In block 410, the target computing node may receive lock state information. In some examples, the lock state information may be included in a persistent volume group moved to the target computing node during failover (e.g., persistent volume group 142 of FIG. 1 and FIG. 2).

Accordingly, target computing nodes that may be used to failover from a down computing node may be able to access a variety of information that may be used to facilitate an efficient and accurate failover. In block 408, the target computing node may process asynchronous write operations. For example, the asynchronous write operations received from the computing node being taken down for failure may be processed. For example, the computing node 120 may process asynchronous write operations received from computing node 118 during failover. In some examples, an SMB process started on the target computing node, such as SMB process 204 on computing node 120 of FIG. 2, may be used to process the asynchronous write operations.

In block 412, lock state may be restored. The computing node 120 may, for example, restore lock state relating to VG1 148 and/or VG2 150 by accessing lock state information stored in persistent volume group 142. Accordingly, lock state information associated with a file share, file shares, and/or one or more portions of file shares stored on VG1 148 and/or VG2 150 may be restored prior to accepting further requests for the data.

In block 414, the target computing node may respond to one or more reconnect requests using the durable handles. For example, a reconnect request may be provided by client 102 of FIG. 1 for a particular file share or portion of a file share that had been subject of a durable open. Once the file share become unavailable, the client 102 may have an opportunity to request to reconnect. The reconnect request may be received by the target computing node, such as computing node 120 in the example of FIG. 2. The durable handle information stored in persistent volume group 142 may allow the SMB process 204 to respond accurately and timely to the reconnect request. In some examples, the target computing node may not service requests for the file share, file shares, and/or portion of file share failed over from another computing node until the asynchronous writes had been processed in block 408. For example, the SMB process 204 and/or FSVM 126 may not provide responses and/or may not forward requests for VG1 148 and/or VG2 150 until block 408 has been completed. This may aid in ensuring the accuracy of the data during and/or after failover. Similarly, the target computing node may not service requests for the file share, file shares, and/or portion of file share failed over from another computing node until the lock state has been implemented from block 410.

In some examples, the target computing node may prioritize reconnect requests for the failed over file share over new requests for the file share. For example, the computing node 120 of FIG. 2 may receive a reconnect request from client 102 for a share, and the computing node 120 may receive additional requests for the share from the same and/or other clients. The computing node 120 (e.g., the FSVM 126 and/or SMB process 204) may process the reconnect request prior to servicing new I/O requests for the file share. Prioritization of reconnect requests may be made in order to reduce or minimize a chance of reconnect requests being received after a threshold time in which the durable handles are available.

The operations of FIG. 3 and FIG. 4 have described operations involved in a failover of a file share from one computing node to another computing node. The failover may occur, for example, responsive to an upgrade or maintenance event. Once the upgrade or maintenance event is complete, the computing node may be brought back up and may become again available. For example, an upgrade may be performed (e.g., by an administrator or administrator system) on the computing node 118. The FSVM 124, SMB process 136, hypervisor, and/or other component of the computing node 118 may be upgraded while the share is failed over to computing node 120. Once an upgrade at computing node 118 is complete, the share may be failed back from computing node 120 to computing node 118. Analogous operations may be performed to fail back the file share from the target computing node to the original computing node (e.g., from computing node 120 to computing node 118 in the examples of FIG. 1 and FIG. 2).

Although not explicitly shown in FIG. 4, in some examples, the durable handles may be cleaned up (e.g., deleted) after a threshold time. In some examples, the threshold time may be 70 seconds. In some examples, the threshold time may be 60 seconds. Other threshold times may be used. The computing node 120 may delete the durable handles from persistent volume group 142 after the threshold time. For example, the failover process 134 and/or SMB process 204 may delete the durable handles.

Examples of systems and methods described herein may include a file server manager in communication with one or more virtualized file servers. Examples of virtualized file servers which may be used to implement virtualized file servers are described in, for example, U.S. Published Patent Application 2017/0235760, entitled “Virtualized file server,” published Aug. 17, 2017 on U.S. application Ser. No. 15/422,420, filed Feb. 1, 2017, both of which documents are hereby incorporated by reference in their entirety for any purpose.

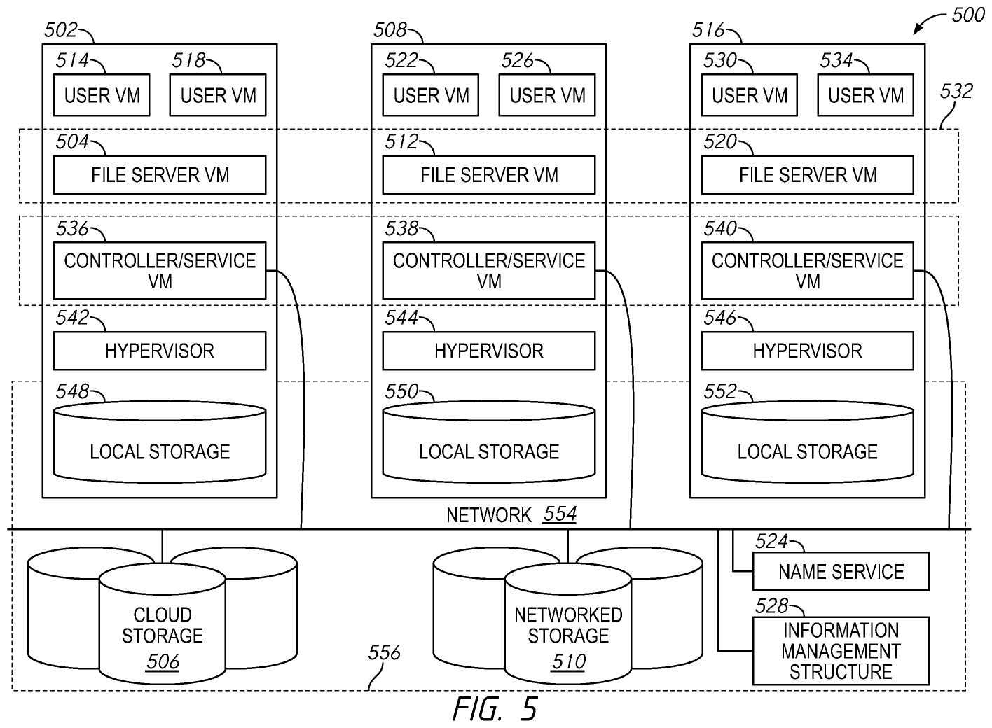

FIG. 5 is a schematic illustration of a clustered virtualization environment 500 implementing a VFS 532 according to particular embodiments. In particular embodiments, the VFS 532 provides file services to user VMs 514, 518, 522, 526, 530, and 534. Each user VM may be a client as used herein and/or a user. The file services may include storing and retrieving data persistently, reliably, and efficiently. The user VMs may execute user processes, such as office applications or the like, on host machines 502, 508, and 516. The stored data may be represented as a set of storage items, such as files organized in a hierarchical structure of folders (also known as directories), which can contain files and other folders, and shares, which can also contain files and folders.

The clustered virtualization environment 500 and/or VFS 532 may be used to implement one or more virtualization platforms and/or virtualized file servers described herein, such as the system 104 of FIG. 1 and/or any other virtualized file server described herein.

The architectures of FIG. 5 can be implemented for a distributed platform that contains multiple host machines 502, 516, and 508 that manage multiple tiers of storage. The multiple tiers of storage may include storage that is accessible through network 554, such as, by way of example and not limitation, cloud storage 506 (e.g., which may be accessible through the internet), network-attached storage 510 (NAS) (e.g., which may be accessible through a local area network (LAN), or a storage area network (SAN). Examples described herein also permit local storage 548, 550, and 552 that is incorporated into or directly attached to the host machine and/or appliance to be managed as part of storage pool 556. Examples of such local storage include solid state drives (SSDs), hard disk drives (HDDs or “spindle drives”), optical disk drives, external drives (e.g., a storage device connected to a host machine via a native drive interface or a serial attached small computer systems interface (SCSI)), or any other direct-attached storage. These storage devices, both direct-attached and network-accessible, collectively form storage pool 556. Virtual disks (or “vDisks”) may be structured from the physical storage devices in storage pool 556. As used herein, the term vDisk refers to the storage abstraction that is exposed by a component of the virtualization platform, such as a controller/service VM (CVM) (e.g., CVM 536) and/or a hypervisor or other storage controller to be used by a user VM (e.g., user VM 514). In particular embodiments, the vDisk may be exposed via iSCSI (internet small computer system interface) or NFS and is mounted as a virtual disk on the user VM. In particular embodiments, vDisks may be organized into one or more VGs.

Each host machine 502, 516, 508 may run virtualization software, such as VMWARE ESX(I), MICROSOFT HYPER-V, or REDHAT KVM. The virtualization software includes hypervisors 542, 544, and 546 to create, manage, and destroy user VMs, as well as managing the interactions between the underlying hardware and user VMs. User VMs may run one or more applications that may operate as “clients” with respect to other elements within clustered virtualization environment 500. A hypervisor may connect to network 554. In particular embodiments, a host machine 502, 508, or 516 may be a physical hardware computing device; in particular embodiments, a host machine 502, 508, or 516 may be a virtual machine.

CVMs 536, 538, and 540 are used to manage storage and input/output (I/O) activities according to particular embodiments. These special VMs act as the storage controller in the currently described architecture. While CVMs are described, in other examples, a different storage controller may be used. Multiple such storage controllers may coordinate within a cluster to form a unified storage controller system. CVMs may run as virtual machines on the various host machines, and work together to form a distributed system that manages all the storage resources, including local storage, NAS 510, and cloud storage 506. The CVMs may connect to network 554 directly, or via a hypervisor. Since the CVMs run independent of hypervisors 542, 544, 546, this means that the current approach can be used and implemented within any virtual machine architecture, since the CVMs of particular embodiments can be used in conjunction with any hypervisor from any virtualization vendor. In some examples, CVMs may not be used and one or more hypervisors (e.g., hypervisors 542, 544, and/or 546) may perform the functions described with respect to the CVMs. In some examples, one or more CVMs may not be present, and the hypervisor and/or other component hosted on the computing nodes may provide the functions attributed to the CVM herein.

A host machine may be designated as a leader node within a cluster of host machines. For example, host machine 508 may be a leader node. A leader node may have a software component designated to perform operations of the leader. For example, CVM 538 on host machine 508 may be designated to perform such operations. A leader may be responsible for monitoring or handling requests from other host machines or software components on other host machines throughout the virtualized environment. If a leader fails, a new leader may be designated. In particular embodiments, a management module (e.g., in the form of an agent) may be running on the leader node and/or in communication with the leader node or virtual machines or containers on the leader node. For example, file server managers described herein may be in communication with the leader node in some examples.

Each CVM 536, 538, and 540 exports one or more block devices or NFS server targets that appear as disks to user VMs 514, 518, 522, 526, 530, and 534. These disks are virtual, since they are implemented by the software running inside CVMs 536, 538, and 540. Thus, to user VMs, CVMs appear to be exporting a clustered storage appliance that contains some disks. All user data (including the operating system) in the user VMs may reside on these virtual disks.

Significant performance advantages can be gained by allowing the virtualization system to access and utilize local storage 548, 550, and 552 as disclosed herein. This is because I/O performance is typically much faster when performing access to local storage as compared to performing access to NAS 510 across a network 554. This faster performance for locally attached storage can be increased even further by using certain types of optimized local storage devices, such as SSDs. Further details regarding methods and mechanisms for implementing the virtualization environment illustrated in FIG. 5 are described in U.S. Pat. No. 8,601,473, which is hereby incorporated by reference in its entirety for any purpose.

As a user VM performs I/O operations (e.g., a read operation or a write operation), the I/O commands of the user VM may be sent to the hypervisor that shares the same server as the user VM. For example, the hypervisor may present to the virtual machines an emulated storage controller, receive an I/O command, and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 556. Additionally or alternatively, CVMs 536, 538, 540 may present an emulated storage controller either to the hypervisor or to user VMs to facilitate I/O operations. CVMs 536, 538, and 540 may be connected to storage within storage pool 556. CVM 536 may have the ability to perform I/O operations using local storage 548 within the same host machine 502, by connecting via network 554 to cloud storage 506 or NAS 510, or by connecting via network 554 to local storage 550 or 552 within another host machine 508 or 516 (e.g., via connecting to another CVM 538 or 540). In particular embodiments, any suitable computing system may be used to implement a host machine.

In particular embodiments, the VFS 532 may include a set of FSVMs 504, 512, and 520 that execute on host machines 502, 508, and 516 and process storage item access operations requested by user VMs executing on the host machines 502, 508, and 516. While described as VMs, it is to be understood that the FSVMs may be implemented using containers in some examples, and/or that containers may be used instead of FSVMs. The containers used instead of an FSVM may implement one or more protocol stacks for file systems (e.g., NFS and/or SMB). The FSVMs 504, 512, and 520 may communicate with storage controllers provided by CVMs 536, 538, 540 and/or hypervisors executing on the host machines 502, 508, 516 to store and retrieve files, folders, SMB shares, or other storage items on local storage 548, 550, 552 associated with, e.g., local to, the host machines 502, 508, 516. The FSVMs 504, 512, 520 may store and retrieve block-level data on the host machines 502, 508, 516, e.g., on the local storage 548, 550, 552 of the host machines 502, 508, 516. The block-level data may include block-level representations of the storage items (e.g., files, shares). The network protocol used for communication between user VMs, FSVMs, and CVMs via the network 554 may be Internet Small Computer System Interface (iSCSI), SMB, NFS, pNFS (parallel NFS), or another appropriate protocol.

For the purposes of VFS 532, host machine 516 may be designated as a leader node within a cluster of host machines. In this case, FSVM 520 on host machine 516 may be designated to perform such operations. A leader may be responsible for monitoring or handling requests from FSVMs on other host machines throughout the virtualized environment. If FSVM 520 fails, a new leader may be designated for VFS 532.

In particular embodiments, the user VMs may send data to the VFS 532 (e.g., to the FSVMs) using write requests, and may receive data from it using read requests. The read and write requests, and their associated parameters, data, and results, may be sent between a user VM and one or more FSVMs located on the same host machine as the user VM or on different host machines from the user VM. The read and write requests may be sent between host machines 502, 508, 516 via network 554, e.g., using a network communication protocol such as iSCSI, CIFS, SMB, TCP, IP, or the like. When a read or write request is sent between two VMs located on the same one of the host machines 502, 508, 516 (e.g., between the user VM 514 and the FSVM 504 located on the host machine 502), the request may be sent using local communication within the host machine 502 instead of via the network 554. As described above, such local communication may be substantially faster than communication via the network 554. The local communication may be performed by, e.g., writing to and reading from shared memory accessible by the user VM 514 and the FSVM 504, sending and receiving data via a local “loopback” network interface, local stream communication, or the like.

In particular embodiments, the storage items stored by the VFS 532, such as files and folders, may be distributed amongst multiple FSVMs 504, 512, 520. In particular embodiments, when storage access requests are received from the user VMs, the VFS 532 identifies FSVMs 504, 512, 520 at which requested storage items, e.g., folders, files, or portions thereof, are stored, and directs the user VMs to the locations of the storage items. The FSVMs 504, 512, 520 may maintain a storage map, such as a sharding map, that maps names or identifiers of storage items to their corresponding locations. The storage map may be a distributed data structure of which copies are maintained at each FSVM 504, 512, 520 and accessed using distributed locks or other storage item access operations. Alternatively, the storage map may be maintained by an FSVM at a leader node such as the FSVM 520, and the other FSVMs 504 and 512 may send requests to query and update the storage map to the leader FSVM 520. Other implementations of the storage map are possible using appropriate techniques to provide asynchronous data access to a shared resource by multiple readers and writers. The storage map may map names or identifiers of storage items in the form of text strings or numeric identifiers, such as folder names, files names, and/or identifiers of portions of folders or files (e.g., numeric start offset positions and counts in bytes or other units) to locations of the files, folders, or portions thereof. Locations may be represented as names of FSVMs, e.g., “FSVM-1,” as network addresses of host machines on which FSVMs are located (e.g., “ip-addr1” or “128.1.1.10”), or as other types of location identifiers.

When a user application executing in a user VM 514 on one of the host machines 502 initiates a storage access operation, such as reading or writing data, the user VM 514 may send the storage access operation in a request to one of the FSVMs 504, 512, 520 on one of the host machines 502, 508, 516. An FSVM 512 executing on a host machine 508 that receives a storage access request may use the storage map to determine whether the requested file or folder is located on the FSVM 512. If the requested file or folder is located on the FSVM 512, the FSVM 512 executes the requested storage access operation. Otherwise, the FSVM 512 responds to the request with an indication that the data is not on the FSVM 512, and may redirect the requesting user VM 514 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 504 by sending a file service operation that creates the file or folder to a CVM 536 and/or hypervisor 542 associated with (e.g., located on the same host machine as) the FSVM 504. The CVM 536 subsequently processes file service commands for that file for the FSVM 504 and sends corresponding storage access operations to storage devices associated with the file. The CVM 536 may associate local storage 548 with the file if there is sufficient free space on local storage 548. Alternatively, the CVM 536 may associate a storage device located on another host machine 502, e.g., in local storage 550, with the file under certain conditions, e.g., if there is insufficient free space on the local storage 548, or if storage access operations between the CVM 536 and the file are expected to be infrequent. Files and folders, or portions thereof, may also be stored on other storage devices, such as the NAS 510 or the cloud storage 506 of the storage pool 556.

In particular embodiments, a name service 524, such as that specified by the Domain Name System (DNS) IP, may communicate with the host machines 502, 508, 516 via the network 554 and may store a database of domain name (e.g., host name) to IP address mappings. The domain names may correspond to FSVMs, e.g., fsvm1.domain.com or ip-addr1.domain.com for an FSVM named “FSVM-1.” The name service 524 may be queried by the user VMs to determine the IP address of a particular host machine 502, 508, 516 given a name of the host machine, e.g., to determine the IP address of the host name ip-addr1 for the host machine 502. The name service 524 may be located on a separate server computer system or on one or more of the host machines 502, 508, 516. The names and IP addresses of the host machines of the VFS 532, e.g., the host machines 502, 508, 516, may be stored in the name service 524 so that the user VMs may determine the IP address of each of the host machines 502, 508, 516, or FSVMs 504, 512, 520. The name of each VFS instance, e.g., each file system such as FS1, FS2, or the like, may be stored in the name service 524 in association with a set of one or more names that contains the name(s) of the host machines 502, 508, 516 or FSVMs 504, 512, 520 of the VFS instance VFS 532. The FSVMs 504, 512, 520 may be associated with the host names ip-addr1, ip-addr2, and ip-addr3, respectively. For example, the file server instance name FS1.domain.com may be associated with the host names ip-addr1, ip-addr2, and ip-addr3 in the name service 524, so that a query of the name service 524 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 524 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 524 for the address of the VFS instance for storage items for which the user VMs do not have a record or cache entry, as described below.

In particular embodiments, each FSVM may have two IP addresses: an external IP address and an internal IP address. The external IP addresses may be used by SMB/CIFS clients, such as user VMs, to connect to the FSVMs. The external IP addresses may be stored in a name service. The IP addresses ip-addr1, ip-addr2, and ip-addr3 described above are examples of external IP addresses. The internal IP addresses may be used for iSCSI communication to CVMs and/or hypervisors, e.g., between the FSVMs 504, 512, 520 and the CVMs 536, 544, 540 and/or hypervisors 542, 544, and/or 546. Other internal communications may be sent via the internal IP addresses as well, e.g., file server configuration information may be sent from the CVMs to the FSVMs using the internal IP addresses, and the CVMs may get file server statistics from the FSVMs via internal communication as needed.

Since the VFS 532 is provided by a distributed set of FSVMs 504, 512, 520, the user VMs that access particular requested storage items, such as files or folders, do not necessarily know the locations of the requested storage items when the request is received. A distributed file system protocol, e.g., MICROSOFT Distributed File System (DFS) or the like, is therefore used, in which a user VM 514 may request the addresses of FSVMs 504, 512, 520 from a name service 524 (e.g., DNS). The name service 524 may send one or more network addresses of FSVMs 504, 512, 520 to the user VM 514, in an order that changes for each subsequent request. These network addresses are not necessarily the addresses of the FSVM 512 on which the storage item requested by the user VM 514 is located, since the name service 524 does not necessarily have information about the mapping between storage items and FSVMs 504, 512, 520. Next, the user VM 514 may send an access request to one of the network addresses provided by the name service, e.g., the address of FSVM 512. The FSVM 512 may receive the access request and determine whether the storage item identified by the request is located on the FSVM 512. If so, the FSVM 512 may process the request and send the results to the requesting user VM 514. However, if the identified storage item is located on a different FSVM 520, then the FSVM 512 may redirect the user VM 514 to the FSVM 520 on which the requested storage item is located by sending a “redirect” response referencing FSVM 520 to the user VM 514. The user VM 514 may then send the access request to FSVM 520, which may perform the requested operation for the identified storage item.

A particular virtualized file server, such as VFS 532, including the items it stores, e.g., files and folders, may be referred to herein as a VFS “instance” and/or a file system and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients such as user VMs by name, e.g., “\Folder-1\File-1” and “\Folder-2\File-2” for two different files named “File-1” and “File-2” in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1\File-1”, in storage access operations. If the storage items are stored on a share (e.g., a shared drive), then the share name may be used to access the storage items, e.g., via the path name “\\Share-1\Folder-1\File-1” to access File-1 in folder Folder-1 on a share named “Share-1.”

In particular embodiments, although the VFS instance may store different folders, files, or portions thereof at different locations, e.g., on different FSVMs, the use of different FSVMs or other elements of storage pool 556 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, are similarly location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 532 determines the location, e.g., FSVM, at which to store a storage item when the storage item is created. For example, an FSVM 504 may attempt to create a file or folder using a CVM 536 on the same host machine 502 as the user VM 518 that requested creation of the file, so that the CVM 536 that controls access operations to the file folder is co-located with the user VM 518. In this way, since the user VM 518 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 532 may also attempt to store the file on a storage device that is local to the CVM being used to create the file, such as local storage, so that storage access operations between the CVM and local storage may use local or short-distance communication.

In particular embodiments, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In particular embodiments, if a virtual machine, such as a user VM 514, CVM 536, or FSVM 504, moves from a host machine 502 to a destination host machine 508, e.g., because of resource availability changes, and data items such as files or folders associated with the VM are not locally accessible on the destination host machine 508, then data migration may be performed for the data items associated with the moved VM to migrate them to the new host machine 508, so that they are local to the moved VM on the new host machine 508. FSVMs may detect removal and addition of CVMs (as may occur, for example, when a CVM fails or is shut down) via the iSCSI protocol or other technique, such as heartbeat messages. As another example, an FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 532 may change the location of the file by, for example, copying the file from its existing location(s), such as local storage 548 of a host machine 502, to its new location(s), such as local storage 550 of host machine 508 (and to or from other host machines, such as local storage 552 of host machine 516 if appropriate), and deleting the file from its existing location(s). Write operations on the file may be blocked or queued while the file is being copied, so that the copy is consistent. The VFS 532 may also redirect storage access requests for the file from an FSVM at the file's existing location to an FSVM at the file's new location.

In particular embodiments, VFS 532 includes at least three FSVMs 504, 512, 520 located on three respective host machines 502, 508, 516. To provide high availability, there may be in some examples a maximum of one FSVM per host machine in a cluster. If two FSVMs are detected on a single host machine, then one of the FSVMs may be moved to another host machine automatically, or the user (e.g., system administrator and/or file server manager) may be notified to move the FSVM to another host machine. The user and/or file server manager may move an FSVM to another host machine using an administrative interface that provides commands for starting, stopping, and moving FSVMs between host machines.

In particular embodiments, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine may result in loss of two-thirds of the FSVMs for the VFS instance, which would be more disruptive and more difficult to recover from than the loss of one-third of the FSVMs for the VFS instance.

In particular embodiments, users, such as system administrators or other users of the user VMs, may expand the cluster of FSVMs by adding additional FSVMs. Each FSVM may be associated with at least one network address, such as an IP address of the host machine on which the FSVM resides. There may be multiple clusters, and all FSVMs of a particular VFS instance are ordinarily in the same cluster. The VFS instance may be a member of a Microsoft Active Directory domain, which may provide authentication and other services such as name service.

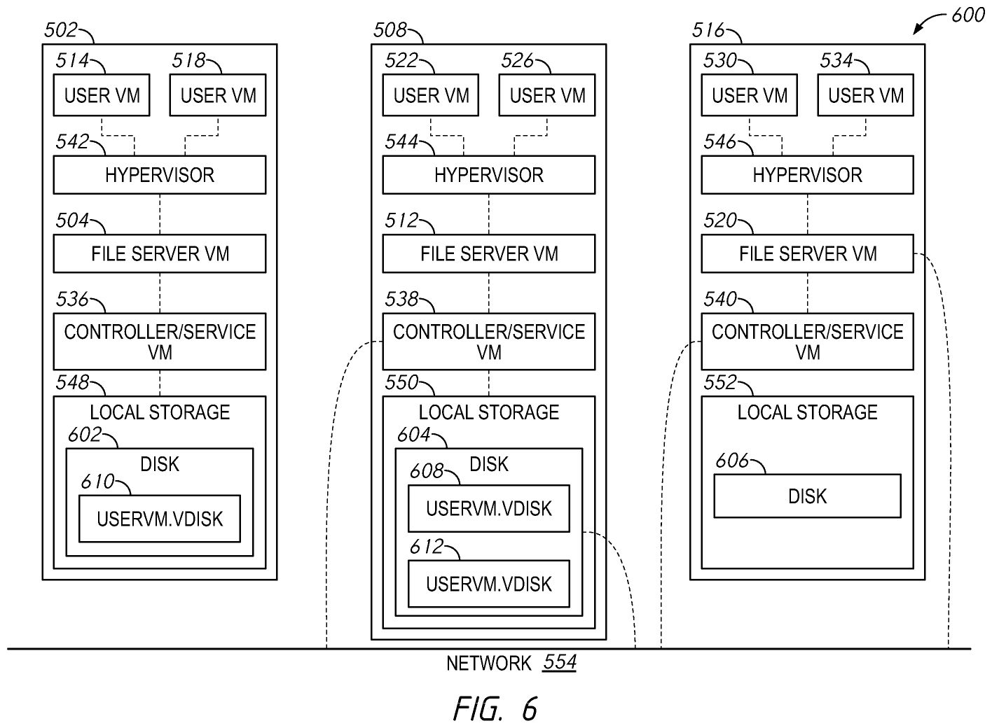

FIG. 6 illustrates data flow within a clustered virtualization environment 600 implementing a VFS instance (e.g., VFS 532) in which stored items such as files and folders used by user VMs are stored locally on the same host machines as the user VMs according to particular embodiments. As described above, one or more user VMs and a CVM and/or hypervisor may run on each host machine. As a user VM processes I/O commands (e.g., a read or write operation), the I/O commands may be sent to the hypervisor on the same server or host machine as the user VM. For example, the hypervisor may present to the user VMs a VFS instance, receive an I/O command, and facilitate the performance of the I/O command by passing the command to an FSVM that performs the operation specified by the command. The VFS may facilitate I/O operations between a user VM and a virtualized file system. The virtualized file system may appear to the user VM as a namespace of mappable shared drives or mountable network file systems of files and directories. The namespace of the virtualized file system may be implemented using storage devices in the local storage, such as disks, onto which the shared drives or network file systems, files, and folders, or portions thereof, may be distributed as determined by the FSVMs. The VFS may thus provide features disclosed herein, such as efficient use of the disks, high availability, scalability, and others. The implementation of these features may be transparent to the user VMs. The FSVMs may present the storage capacity of the disks of the host machines as an efficient, highly-available, and scalable namespace in which the user VMs may create and access shares, files, folders, and the like.

As an example, a network share may be presented to a user VM as one or more discrete virtual disks, but each virtual disk may correspond to any part of one or more virtual or physical disks within a storage pool. Additionally or alternatively, the FSVMs may present a VFS either to the hypervisor or to user VMs of a host machine to facilitate I/O operations. The FSVMs may access the local storage via CVMs, other storage controllers, hypervisors, or other components of the host machine. As described herein, a CVM 536 may have the ability to perform I/O operations using local storage 548 within the same host machine 502 by connecting via the network 554 to cloud storage or NAS, or by connecting via the network 554 to local storage 550, 552 within another host machine 508, 516 (e.g., by connecting to another CVM 538, 540).

In particular embodiments, each user VM may access one or more virtual disk images stored on one or more disks of the local storage, the cloud storage, and/or the NAS. The virtual disk images may contain data used by the user VMs, such as operating system images, application software, and user data, e.g., user home folders and user profile folders. For example, FIG. 6 illustrates three virtual machine images 610, 608, 612. The virtual machine image 610 may be a file named “UserVM.vdisk” (or the like) stored on disk 602 of local storage 548 of host machine 502. The virtual machine image 610 may store the contents of the user VM 514's hard drive. The disk 602 on which the virtual machine image 610 is “local to” the user VM 514 on host machine 502 because the disk 602 is in local storage 548 of the host machine 502 on which the user VM 514 is located. Thus, the user VM 514 may use local (intra-host machine) communication to access the virtual machine image 610 more efficiently, e.g., with less latency and higher throughput, than would be the case if the virtual machine image 610 were stored on disk 604 of local storage 550 of a different host machine 508, because inter-host machine communication across the network 554 would be used in the latter case. Similarly, a virtual machine image 608, which may be a file named “UserVM.vdisk” (or the like), is stored on disk 604 of local storage 550 of host machine 508, and the image 608 is local to the user VM 522 located on host machine 508. Thus, the user VM 522 may access the virtual machine image 608 more efficiently than the virtual machine 518 on host machine 502, for example. In another example, the CVM 540 may be located on the same host machine 516 as the user VM 530 that accesses a virtual machine image 612 (UserVM.vdisk) of the user VM 530, with the virtual machine image 612 being stored on a different host machine 508 than the user VM 530 and the CVM 540. In this example, communication between the user VM 530 and the CVM 540 may still be local, e.g., more efficient than communication between the user VM 530 and a CVM 538 on a different host machine 508, but communication between the CVM 540 and the disk 604 on which the virtual machine image 612 is stored is via the network 554, as shown by the dashed lines between CVM 540 and the network 554 and between the network 554 and local storage 550. The communication between CVM 540 and the disk 604 is not local, and thus may be less efficient than local communication such as may occur between the CVM 540 and a disk 606 in local storage 552 of host machine 516. Further, a user VM 530 on host machine 516 may access data such as the virtual machine image 612 stored on a remote (e.g., non-local) disk 604 via network communication with a CVM 538 located on the remote host machine 508. This case may occur if CVM 540 is not present on host machine 516, e.g., because CVM 540 has failed, or if the FSVM 520 has been configured to communicate with local storage 550 on host machine 508 via the CVM 538 on host machine 508, e.g., to reduce computational load on host machine 516.

In particular embodiments, since local communication is expected to be more efficient than remote communication, the FSVMs may store storage items, such as files or folders, e.g., the virtual disk images, as block-level data on local storage of the host machine on which the user VM that is expected to access the files is located. A user VM may be expected to access particular storage items if, for example, the storage items are associated with the user VM, such as by configuration information. For example, the virtual disk image 610 may be associated with the user VM 514 by configuration information of the user VM 514. Storage items may also be associated with a user VM via the identity of a user of the user VM. For example, files and folders owned by the same user ID as the user who is logged into the user VM 514 may be associated with the user VM 514. If the storage items expected to be accessed by a user VM 514 are not stored on the same host machine 502 as the user VM 514, e.g., because of insufficient available storage capacity in local storage 548 of the host machine 502, or because the storage items are expected to be accessed to a greater degree (e.g., more frequently or by more users) by a user VM 522 on a different host machine 508, then the user VM 514 may still communicate with a local CVM 536 to access the storage items located on the remote host machine 508, and the local CVM 536 may communicate with local storage 550 on the remote host machine 508 to access the storage items located on the remote host machine 508. If the user VM 514 on a host machine 502 does not or cannot use a local CVM 536 to access the storage items located on the remote host machine 508, e.g., because the local CVM 536 has crashed or the user VM 514 has been configured to use a remote CVM 538, then communication between the user VM 514 and local storage 550 on which the storage items are stored may be via a remote CVM 538 using the network 554, and the remote CVM 538 may access local storage 550 using local communication on host machine 508. As another example, a user VM 514 on a host machine 502 may access storage items located on a disk 606 of local storage 552 on another host machine 516 via a CVM 538 on an intermediary host machine 508 using network communication between the host machines 502 and 508 and between the host machines 508 and 516.

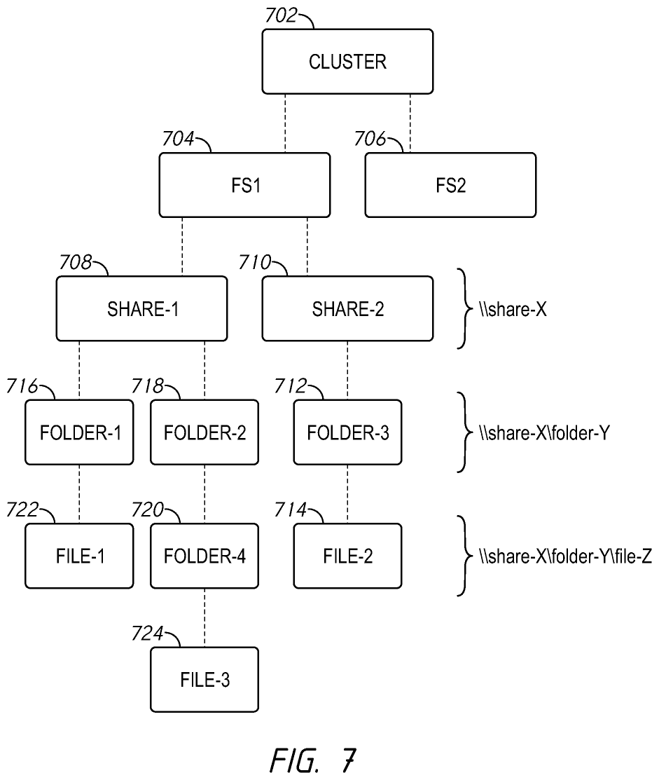

FIG. 7 illustrates an example hierarchical structure of a VFS instance (e.g., a file system) in a cluster (such as a virtualized file server) according to particular embodiments. A cluster 702 contains two VFS instances, FS1 704 and FS2 706. For example, the cluster 702 may be used to implement and/or may be implemented by a virtualized file server described herein, such as virtualized file server of FIG. 1 and/or FIG. 2. Each VFS instance as shown in FIG. 7 may be identified by a name such as “\\instance”, e.g., “\\FS1” for Windows file systems, or a name such as “instance”, e.g., “FS1” for UNIX-type file systems. The VFS instance FS1 704 contains shares, including Share-1 708 and Share-2 710. Shares may have names such as “Users” for a share that stores user home directories, or the like. Each share may have a path name such as “\\FS1\Share-1” or “\\FS1\Users”. As an example and not by way of limitation, a share may correspond to a disk partition or a pool of file system blocks on Windows and UNIX-type file systems. As another example and not by way of limitation, a share may correspond to a folder or directory on a VFS instance. Shares may appear in the file system instance as folders or directories to users of user VMs. Share-1 708 includes two folders, Folder-1 716, and Folder-2 718, and may also include one or more files (e.g., files not in folders). Each folder Folder-1 716, Folder-2 718 may include one or more files 722, 724. Share-2 710 includes a folder Folder-3 712, which includes a file File-2 714. Each folder has a folder name such as “Folder-1”, “Users”, or “Sam” and a path name such as “\\FS1\Share-1\Folder-1” (in Windows) or “share-1:/fs1/Users/Sam” (in UNIX). Similarly, each file has a file name such as “File-1” or “Forecast.xls” and a path name such as “\\FS1\Share-1\Folder-1\File-1” or “share-1:/fs1/Users/Sam/Forecast.xls”.

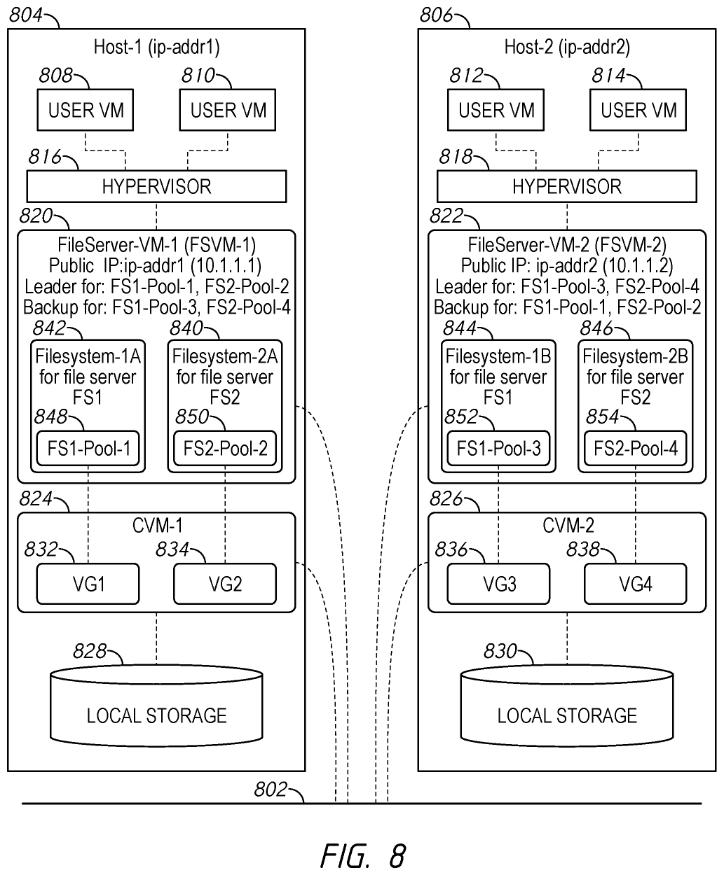

FIG. 8 illustrates two example host machines 804 and 806, each providing file storage services for portions of two VFS instances FS1 and FS2 according to particular embodiments. The first host machine, Host-1 804, includes two user VMs 808, 810, a hypervisor 816, an FSVM named “FileServer-VM-1” (abbreviated “FSVM-1”) 820, a Controller/Service VM named “CVM-1” 824, and local storage 828. Host-1 804's FSVM-1 820 has an IP network address of 10.1.1.1, which is an address of a network interface on Host-1 804. Host-1 804 has a hostname ip-addr1, which may correspond to Host-1 804's IP address 10.1.1.1. The second host machine, Host-2 806, includes two user VMs 812, 814, a hypervisor 818, a File Server VM named “FileServer-VM-2” (abbreviated “FSVM-2”) 822, a CVM named “CVM-2” 826, and local storage 830. Host-2 806's FSVM-2 822 has an IP network address of 10.1.1.2, which is an address of a network interface on Host-2 806.

In particular embodiments, file systems FileSystem-1A 842 and FileSystem-2A 840 implement the structure of files and folders for portions of the FS1 and FS2 file server instances, respectively, that are located on (e.g., served by) FSVM-1 820 on Host-1 804. Other file systems on other host machines may implement other portions of the FS1 and FS2 file server instances. The file systems FileSystem-1A 842 and FileSystem-2A 840 may implement the structure of at least a portion of a file server instance by translating file system operations, such as opening a file, writing data to or reading data from the file, deleting a file, and so on, to disk I/O operations such as seeking to a portion of the disk, reading or writing an index of file information, writing data to or reading data from blocks of the disk, allocating or de-allocating the blocks, and so on. The file systems FileSystem-1A 842 and FileSystem-2A 840 may thus store their file system data, including the structure of the folder and file hierarchy, the names of the storage items (e.g., folders and files), and the contents of the storage items on one or more storage devices, such as local storage 828. The particular storage device or devices on which the file system data for each file system are stored may be specified by an associated file system pool (e.g., FS1-Pool-1 848 and FS2-Pool-2 850). For example, the storage device(s) on which data for FileSystem-1A 842 and FileSystem-2A 840 are stored may be specified by respective file system pools FS1-Pool-1 848 and FS2-Pool-2 850. The storage devices for the pool may be selected from volume groups provided by CVM-1 824, such as volume group VG1 832 and volume group VG2 834. Each volume group VG1 832, VG2 834 may include a group of one or more available storage devices that are present in local storage 828 associated with (e.g., by iSCSI communication) the CVM-1 824. The CVM-1 824 may be associated with a local storage 828 on the same host machine Host-1 804 as the CVM-1 824, or with a local storage 830 on a different host machine Host-2 806. The CVM-1 824 may also be associated with other types of storage, such as cloud storage, networked storage or the like. Although the examples described herein include particular host machines, virtual machines, file servers, file server instances, file server pools, CVMs, VGs, and associations there between, any number of host machines, virtual machines, file servers, file server instances, file server pools, CVMs, VGs, and any associations there between are possible and contemplated.

In particular embodiments, the file system pool FS1-Pool-1 848 may associate any storage device in one of the volume groups VG1 832, VG2 834 of storage devices that are available in local storage 828 with the file system FileSystem-1A 842. For example, the file system pool FS1-Pool-1 848 may specify that a disk device named hd1 in the volume group VG1 832 of local storage 828 is a storage device for FileSystem-1A 842 for file server FS1 on FSVM-1 820. A file system pool FS2-Pool-2 850 may specify a storage device FileSystem-2A 840 for file server FS2 on FSVM-1 820. The storage device for FileSystem-2A 840 may be, e.g., the disk device hd1, or a different device in one of the volume groups VG1 832, VG2 834, such as a disk device named “hd2” in volume group VG2 834. Each of the file systems FileSystem-1A 842, FileSystem-2A 840 may be, e.g., an instance of the NTFS file system used by the Windows operating system, of the UFS UNIX file system, or the like. The term “file system” may also be used herein to refer to an instance of a type of file system, e.g., a particular structure of folders and files with particular names and content.

In one example, referring to FIG. 7 and FIG. 8, an FS1 hierarchy rooted at VFS instance FS1 704 may be located on FSVM-1 820 and stored in file system instance FileSystem-1A 842. That is, the file system instance FileSystem-1A 842 may store the names of the shares and storage items (such as folders and files), as well as the contents of the storage items, shown in the hierarchy at and below File Server FS1 704. A portion of the FS1 hierarchy shown in FIG. 7, such as the portion rooted at Folder-2 718, may be located on FileServer-VM-2 822 on Host-2 806 instead of FileServer-VM-1 820, in which case the file system instance FileSystem-1B 844 may store the portion of the FS1 hierarchy rooted at Folder-2 718, including Folder-3 712, Folder-4 720 and File-3 724. Similarly, an FS2 hierarchy rooted at File Server FS2 706 in FIG. 7 may be located on FileServer-VM-1 820 and stored in file system instance FileSystem-2A 840. The FS2 hierarchy may be split into multiple portions (not shown), such that one portion is located on FileServer-VM-1 820 on Host-1 804, and another portion is located on FileServer-VM-2 822 on Host-2 806 and stored in file system instance FileSystem-2B 846.

In particular embodiments, FileServer-VM-1 (abbreviated FSVM-1) 820 on Host-1 804 is a leader for a portion of file server instance FS1 and a portion of FS2, and is a backup for another portion of FS1 and another portion of FS2. The portion of FS1 for which FileServer-VM-1 820 is a leader corresponds to a storage pool labeled FS1-Pool-1 848. FileServer-VM-1 is also a leader for FS2-Pool-2 850, and is a backup (e.g., is prepared to become a leader upon request, such as in response to a failure of another FSVM) for FS1-Pool-3 852 and FS2-Pool-4 854 on Host-2 806. In particular embodiments, FileServer-VM-2 (abbreviated FSVM-2) 822 is a leader for a portion of file server instance FS1 and a portion of FS2, and is a backup for another portion of FS1 and another portion of FS2. The portion of FS1 for which FSVM-2 822 is a leader corresponds to a storage pool labeled FS1-Pool-3 852. FSVM-2 822 is also a leader for FS2-Pool-4 854, and is a backup for FS1-Pool-1 848 and FS2-Pool-2 850 on Host-1 804.

In particular embodiments, the file server instances FS1, FS2 provided by the FSVMs 820 and 822 may be accessed by user VMs 808, 810, 812 and 814 via a network file system protocol such as SMB, CIFS, NFS, or the like. Each FSVM 820 and 822 may provide what appears to client applications on user VMs 808, 810, 812 and 814 to be a single file system instance, e.g., a single namespace of shares, files and folders, for each file server instance. However, the shares, files, and folders in a file server instance such as FS1 may actually be distributed across multiple FSVMs 820 and 822. For example, different folders in the same file server instance may be associated with different corresponding FSVMs 820 and 822 and CVMs 824 and 826 on different host machines Host-1 804 and Host-2 806.

The example file server instance FS1 704 shown in FIG. 7 has two shares, Share-1 708 and Share-2 710. Share-1 708 may be located on FSVM-1 820, CVM-1 824, and local storage 828. NFS protocol requests from user VMs to read or write data on file server instance FS1 704 and any share, folder, or file in the instance may be sent to FSVM-1 820. FSVM-1 820 (or another component, such as a hypervisor in some examples) may determine whether the requested data, e.g., the share, folder, file, or a portion thereof, referenced in the request, is located on FSVM-1 820, and FSVM-1 820 is a leader for the requested data. If not, FSVM-1 820 may respond to the requesting user VM with an indication that the requested data is not covered by (e.g., is not located on or served by) FSVM-1 820. Otherwise, the requested data is covered by (e.g., is located on or served by) FSVM-1 820, so FSVM-1 820 may send iSCSI protocol requests to a CVM that is associated with the requested data. Note that the CVM associated with the requested data may be the CVM-1 824 on the same host machine as the FSVM-1 820, or a different CVM on a different host machine 806, depending on the configuration of the VFS. In this example, the requested Share-1 is located on FSVM-1 820, so FSVM-1 820 processes the request. To provide for path availability, multipath I/O (MPIO) may be used for communication with the FSVM, e.g., for communication between FSVM-1 820 and CVM-1 824. The active path may be set to the CVM that is local to the FSVM (e.g., on the same host machine) by default. The active path may be set to a remote CVM instead of the local CVM, e.g., when a failover occurs.

Continuing with the data request example, the associated CVM is CVM-1 824, which may in turn access the storage device associated with the requested data as specified in the request, e.g., to write specified data to the storage device or read requested data from a specified location on the storage device. In this example, the associated storage device is in local storage 828, and may be an HDD or SSD. CVM-1 824 may access the HDD or SSD via an appropriate protocol, e.g., iSCSI, SCSI, SATA, or the like. CVM-1 824 may send the results of accessing local storage 828, e.g., data that has been read, or the status of a data write operation, to CVM-1 824 via, e.g., SATA, which may in turn send the results to FSVM-1 820 via, e.g., iSCSI. FSVM-1 820 may then send the results to the user VM via SMB through the hypervisor 816.

Share-2 710 may be located on FSVM-2 822, on Host-2. Network file service protocol requests from user VMs to read or write data on Share-2 may be directed to FSVM-2 822 on Host-2 by other FSVMs. Alternatively, user VMs may send such requests directly to FSVM-2 822 on Host-2, which may process the requests using CVM-2 826 and local storage 830 on Host-2 as described above for FSVM-1 820 on Host-1.

A file server instance such as FS1 704 in FIG. 7 may appear as a single file system instance (e.g., a single namespace of folders and files that are accessible by their names or pathnames without regard for their physical locations), even though portions of the file system are stored on different host machines. Since each FSVM may provide a portion of a file server instance, each FSVM may have one or more “local” file systems that provide the portion of the file server instance (e.g., the portion of the namespace of files and folders) associated with the FSVM.

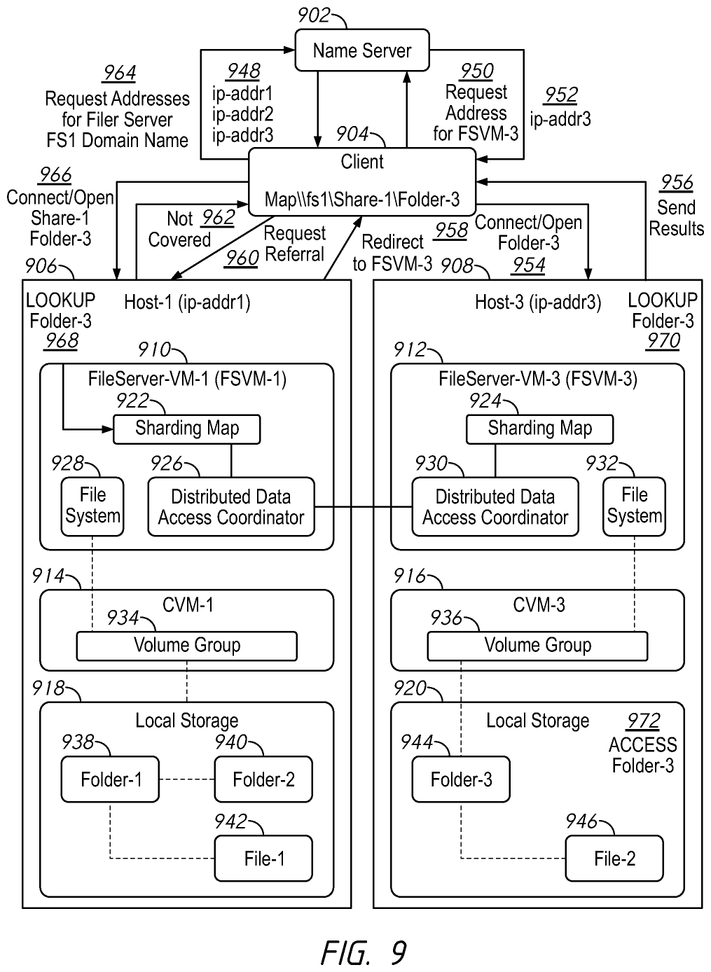

FIG. 9 illustrates example interactions between a client 904 and host machines 906 and 908 on which different portions of a VFS instance are stored according to particular embodiments. A client 904, e.g., an application program executing in one of the user VMs and on the host machines of a virtualized file server described herein requests access to a folder \\FS1.domain.name\Share-1\Folder-3. The request may be in response to an attempt to map \FS1.domain.name\Share-1 to a network drive in the operating system executing in the user VM followed by an attempt to access the contents of Share-1 or to access the contents of Folder-3, such as listing the files in Folder-3.

FIG. 9 shows interactions that occur between the client 904, FSVMs 910 and 912 on host machines 906 and 908, and a name server 902 when a storage item is mapped or otherwise accessed. The name server 902 may be provided by a server computer system, such as one or more of the host machines 906, 908 or a server computer system separate from the host machines 906, 908. In one example, the name server 902 may be provided by an active directory service executing on one or more computer systems and accessible via the network. The interactions are shown as arrows that represent communications, e.g., messages sent via the network. Note that the client 904 may be executing in a user VM, which may be co-located with one of the FSVMs 910 and 912. In such a co-located case, the arrows between the client 904 and the host machine on which the FSVM is located may represent communication within the host machine, and such intra-host machine communication may be performed using a mechanism different from communication over the network, e.g., shared memory or inter-process communication.

In particular embodiments, when the client 904 requests access to Folder-3, a VFS client component executing in the user VM may use a distributed file system protocol such as Microsoft DFS, or the like, to send the storage access request to one or more of the FSVMs described herein. To access the requested file or folder, the client determines the location of the requested file or folder, e.g., the identity and/or network address of the FSVM on which the file or folder is located. The client may query a domain cache of FSVM network addresses that the client has previously identified (e.g., looked up). If the domain cache contains the network address of an FSVM associated with the requested folder name \\FS1.domain.name\Share-1\Folder-3, then the client retrieves the associated network address from the domain cache and sends the access request to the network address, starting at step 964 as described below.

In particular embodiments, at step 964, the client may send a request for a list of addresses of FSVMs to a name server 902. The name server 902 may be, e.g., a DNS server or other type of server, such as a Microsoft domain controller (not shown), that has a database of FSVM addresses. At step 948, the name server 902 may send a reply that contains a list of FSVM network addresses, e.g., ip-addr1, ip-addr2, and ip-addr3, which correspond to the FSVMs in this example. At step 966, the client 904 may send an access request to one of the network addresses, e.g., the first network address in the list (ip-addr1 in this example), requesting the contents of Folder-3 of Share-1. By selecting the first network address in the list, the particular FSVM to which the access request is sent may be varied, e.g., in a round-robin manner by enabling round-robin DNS (or the like) on the name server 902. The access request may be, e.g., an SMB connect request, an NFS open request, and/or appropriate request(s) to traverse the hierarchy of Share-1 to reach the desired folder or file, e.g., Folder-3 in this example.

At step 968, FileServer-VM-1 (FSVM-1) 910 may process the request received at step 966 by searching a mapping or lookup table, such as a sharding map 922, for the desired folder or file. The map 922 maps stored objects, such as shares, folders, or files, to their corresponding locations, e.g., the names or addresses of FSVMs. The map 922 may have the same contents on each host machine, with the contents on different host machines being synchronized using a distributed data store as described below. For example, the map 922 may contain entries that map Share-1 and Folder-1 to the file server FSVM-1 910, and Folder-3 to the file server FSVM-3 912. An example map is shown in Table 1 below. While the example of FIG. 9 is depicted and described with respect to the FSVM processing the request, in some examples, one or more other components of a virtualized system may additionally or instead process the request (e.g., a CVM and/or a hypervisor).

| Stored Object | Location |
|---|---|
| Folder-1 | FSVM-1 |
| Folder-2 | FSVM-1 |
| File-1 | FSVM-1 |
| Folder-3 | FSVM-3 |
| File-2 | FSVM-3 |

In particular embodiments, the map 922 or 924 may be accessible on each of the host machines. The maps may be copies of a distributed data structure that are maintained and accessed at each FSVM using distributed data access coordinators 926 and 930. The distributed data access coordinators 926 and 930 may be implemented based on distributed locks or other storage item access operations. Alternatively, the distributed data access coordinators 926 and 930 may be implemented by maintaining a master copy of the maps 922 and 924 at a leader node such as the host machine 908, and using distributed locks to access the master copy from each of FSVM-1 910 and FSVM-3 912. The distributed data access coordinators 926 and 930 may be implemented using distributed locking, leader election, or related features provided by a centralized coordination service for maintaining configuration information, naming, providing distributed synchronization, and/or providing group services (e.g., APACHE ZOOKEEPER or other distributed coordination software). Since the map 922 indicates that Folder-3 is located at FSVM-3 912 on Host-3 908, the lookup operation at step 968 determines that Folder-3 is not located at FSVM-1 910 on Host-1 906. Thus, at step 962 the FSVM-1 910 (or other component of the virtualized system) sends a response, e.g., a “Not Covered” DFS response, to the client 904 indicating that the requested folder is not located at FSVM-1 910. At step 960, the client 904 sends a request to FSVM-1 910 for a referral to the FSVM on which Folder-3 is located. FSVM-1 910 uses the map 922 to determine that Folder-3 is located at FSVM-3 912 on Host-3 908, and at step 958 returns a response, e.g., a “Redirect” DFS response, redirecting the client 904 to FSVM-3 912. The client 904 may then determine the network address for FSVM-3 912, which is ip-addr3 (e.g., a host name “ip-addr3.domain name” or an IP address “10.1.1.3”). The client 904 may determine the network address for FSVM-3 912 by searching a cache stored in memory of the client 904, which may contain a mapping from FSVM-3 912 to ip-addr3 cached in a previous operation. If the cache does not contain a network address for FSVM-3 912, then at step 950 the client 904 may send a request to the name server 902 to resolve the name for FSVM-3 912. The name server may respond with the resolved address, ip-addr3, at step 952. The client 904 may then store the association between FSVM-3 912 and ip-addr3 in the client 904's cache.

In particular embodiments, failure of FSVMs may be detected using the centralized coordination service. For example, using the centralized coordination service, each FSVM may create a lock on the host machine on which the FSVM is located using ephemeral nodes of the centralized coordination service (which are different from host machines but may correspond to host machines). Other FSVMs may volunteer for leadership of resources of remote FSVMs on other host machines, e.g., by requesting a lock on the other host machines. The locks requested by the other nodes are not granted unless communication to the leader host machine is lost, in which case the centralized coordination service deletes the ephemeral node and grants the lock to one of the volunteer host machines, which becomes the new leader. For example, the volunteer host machines may be ordered by the time at which the centralized coordination service received their requests, and the lock may be granted to the first host machine on the ordered list. The first host machine on the list may thus be selected as the new leader. The FSVM on the new leader has ownership of the resources that were associated with the failed leader FSVM until the failed leader FSVM is restored, at which point the restored FSVM may reclaim the local resources of the host machine on which it is located.

At step 954, the client 904 may send an access request to FSVM-3 912 at ip-addr3 on Host-3 908 requesting the contents of Folder-3 of Share-1. At step 970, FSVM-3 912 queries FSVM-3's copy of the map 924 using FSVM-3's instance of the distributed data access coordinator 930. The map 924 indicates that Folder-3 is located on FSVM-3, so at step 972 FSVM-3 accesses the file system 932 to retrieve information about Folder-3 944 and its contents (e.g., a list of files in the folder, which includes File-2 946) that are stored on the local storage 920. FSVM-3 may access local storage 920 via CVM-3 916, which provides access to local storage 920 via a volume group 936 that contains one or more volumes stored on one or more storage devices in local storage 920. At step 956, FSVM-3 may then send the information about Folder-3 and its contents to the client 904. Optionally, FSVM-3 may retrieve the contents of File-2 and send them to the client 904, or the client 904 may send a subsequent request to retrieve File-2 as needed.

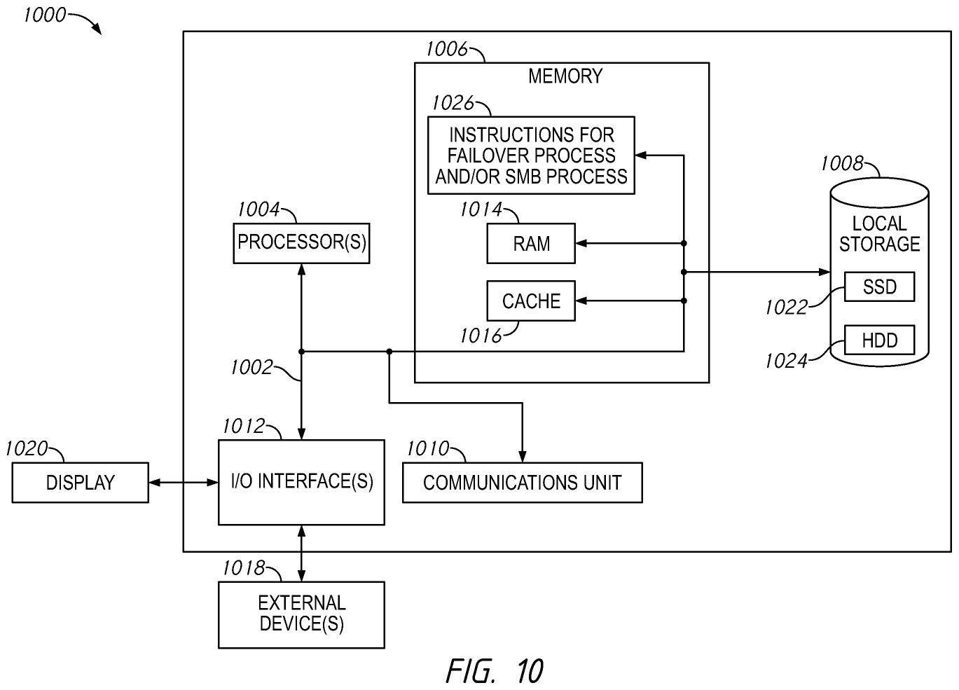

FIG. 10 depicts a block diagram of components of a computing system in accordance with examples described herein. It should be appreciated that FIG. 10 provides only an illustration of one implementation and does not imply any limitations with regard to the environments in which different embodiments may be implemented. Many modifications to the depicted environment may be made. The computing system may be used to implement and/or may be implemented by the one or more computing nodes of a virtualized file server, such as in the system of FIG. 1, for example. The components shown in FIG. 10 are exemplary only, and it is to be understood that additional, fewer, and/or different components may be used in other examples.

The computing node 1000 includes one or more communications fabric(s) 1002, which provide communications between one or more processor(s) 1004, memory 1006, local storage 1008, communications unit 1010, and/or I/O interface(s) 1012. The communications fabric(s) 1002 can be implemented with any architecture designed for passing data and/or control information between processors (such as microprocessors, communications and network processors, etc.), system memory, peripheral devices, and any other hardware components within a system. For example, the communications fabric(s) 1002 can be implemented with one or more buses.

The memory 1006 and the local storage 1008 may be computer-readable storage media. In the example of FIG. 10, the memory 1006 includes random access memory (RAM) 1014 and cache 1016. In general, the memory 1006 can include any suitable volatile or non-volatile computer-readable storage media. In this embodiment, the local storage 1008 includes an SSD 1022 and an HDD 1024. The memory 1006 may include executable instructions for providing a an FSVM and/or a failover process and/or an SMB process 1026. The instructions may include instructions for providing a failover process and/or SMB process 1026. The instructions for providing a failover process and/or SMB process 1026 may be used to implement FSVMs, failover processes, and/or SMB processes described herein, including those described with reference to FIG. 1 and FIG. 2.

Various computer instructions, programs, files, images, etc., may be stored in local storage 1008 and/or memory 1006 for execution by one or more of the respective processor(s) 1004 via one or more memories of memory 1006. In some examples, local storage 1008 includes a magnetic HDD 1024. Alternatively, or in addition to a magnetic HDD, local storage 1008 can include the SSD 1022, a semiconductor storage device, a read-only memory (ROM), an erasable programmable read-only memory (EPROM), a flash memory, or any other computer readable storage media that is capable of storing program instructions or digital information.

The media used by local storage 1008 may also be removable. For example, a removable hard drive may be used for local storage 1008. Other examples include optical and magnetic disks, thumb drives, and smart cards that are inserted into a drive for transfer onto another computer readable storage medium that is also part of local storage 1008.

Communications unit 1010, in some examples, provides for communications with other data processing systems or devices. For example, communications unit 1010 may include one or more network interface cards. Communications unit 1010 may provide communications through the use of either or both physical and wireless communications links.

I/O interface(s) 1012 may allow for input and output of data with other devices that may be connected to computing node 1000. For example, I/O interface(s) 1012 may provide a connection to external device(s) 1018 such as a keyboard, a keypad, a touch screen, and/or some other suitable input device. External device(s) can also include portable computer readable storage media such as, for example, thumb drives, portable optical or magnetic disks, and memory cards. Software and data used to practice embodiments of the present invention can be stored on such portable computer readable storage media and can be loaded onto and/or encoded in memory 1006 and/or local storage 1008 via I/O interface(s) 1012 in some examples. I/O interface(s) 1012 may connect to a display 1020. Display 1020 may provide a mechanism to display data to a user and may be, for example, a computer monitor.

From the foregoing it will be appreciated that, although specific embodiments have been described herein for purposes of illustration, various modifications may be made while remaining within the scope of the claimed technology.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signal may be provided directly to and/or received directly from the recited components without intervening components, but also may be provided to and/or received from the certain components through intervening components.

What is claimed is:

1. A system comprising:
a first computing node configured to host:
a first server message block (SMB) process configured to provide access to a file share, the file share configured to receive asynchronous writes;
a failover process;
a persistent volume group coupled to the first computing node, the persistent volume group configured to store durable handle state for the file share; and
a second computing node configured to host a second SMB process;
wherein the failover process is configured to move the persistent volume group to the second computing node in advance of an outage of the first SMB process, and the failover process is further configured to flush the asynchronous writes to disk in advance of the outage; and
wherein the second SMB process is configured to read a durable handle for the file share from the persistent volume group and respond to reconnect requests for the file share.

2. The system of claim 1, wherein the file share comprises a non-continuous availability (CA) file share.

3. The system of claim 1, wherein the failover process is configured to cause the second SMB process to service access requests for the file share responsive to the outage of the first SMB process.

4. The system of claim 1, wherein the second computing node is configured to prioritize reconnect requests for the file share over other requests for the file share.

5. The system of claim 1, wherein the persistent volume group is further configured to store lock information for the file share.

6. The system of claim 5, wherein the second computing node is further configured to access the lock information from the persistent volume group and provide lock states indicated by the lock information.

7. The system of claim 6, wherein the second computing node is configured to provide the lock states prior to responding to requests for the file share.

8. The system of claim 1, wherein the second computing node is configured to receive the asynchronous writes flushed to disk, and wherein the second computing node is configured to process the asynchronous writes for the file share prior to responding to requests for access to the file share.

9. At least one non-transitory computer readable medium encoded with instructions which, when executed, cause a system to perform operations responsive to an indication of a failover event, the operations comprising:
flush asynchronous write operations for a file share to disk at a first computing node;
move a persistent volume group to a second computing node, the persistent volume group storing durable handles for the file share; and
failover an SMB process from the first computing node to the second computing node, wherein the SMB process is configured to provide access to the file share.

10. The non-transitory computer readable medium of claim 9, wherein the operations further comprise:
store the durable handles for the file share to the persistent volume group.

11. The non-transitory computer readable medium of claim 9, wherein the operations further comprise:
move the persistent volume group to the second computing node, the persistent volume group storing lock state for the file share.

12. The non-transitory computer readable medium of claim 11, wherein the operations further comprise:
read and implement the lock state.

13. The non-transitory computer readable medium of claim 9, the operations further comprising:
receive the indication of the failover event.

14. The non-transitory computer readable medium of claim 9, wherein the operations further comprise:
provide the asynchronous write operations to the second computing node.

15. The non-transitory computer readable medium of claim 9, wherein the failover event comprises an upgrade.

16. At least one non-transitory computer readable medium encoded with instructions which, when executed, cause a system to perform operations responsive to an indication of a failover event, the operations comprising:
receive, at a second computing node, from a first computing node, a persistent volume group, the persistent volume group storing durable handles for a file share;
receive, from the first computing node, asynchronous write operations for the file share;
process the asynchronous write operations for the file share utilizing an SMB process at the second computing node; and
respond to a reconnect request for the file share at the second computing node, including accessing the durable handles for the file share.

17. The non-transitory computer readable medium of claim 16, wherein the operations further comprise:
prioritize the reconnect request for the file share over another request for the file share.

18. The non-transitory computer readable medium of claim 16, wherein the persistent volume group further is configured to store lock state for the file share.

19. The non-transitory computer readable medium of claim 18, wherein the operations further comprise:
restore the lock state from the persistent volume group.

20. The non-transitory computer readable medium of claim 18, wherein the operations further comprise:
delete the durable handles after a threshold time.

21. The non-transitory computer readable medium of claim 18, wherein the operations further comprise:
receive an indication of a failover event;
wherein the asynchronous write operations and the persistent volume group are responsive to the indication of the failover event.

22. The non-transitory computer readable medium of claim 21, wherein the failover event comprises an upgrade of the first computing node.
